(19) United States
(12) Patent Application Publication
(10) Pub. No.: US 2026/0048315 A1
(43) Pub. Date: Feb. 19, 2026

(54) AI-Enabled Mobile Tennis Ball Feeder and Training System

(71) Applicant: TENSA SPORTS, INC., Bainbridge Island, WA (US)

(72) Inventors: Logan Spears, Bainbridge Island, WA (US); Sarah Shonnard, Bainbridge Island, WA (US); Sheldon Maciel, British Colombia (CA); Jurriaan Barkey Wolf, The Haag (NL); Josh Davison, Auburn, WA (US)

(73) Assignee: TENSA SPORTS, INC., Bainbridge Island, WA (US)

(21) Appl. No.: 19/301,644

(22) Filed: Aug. 15, 2025

Related U.S. Application Data
(60) Provisional application No. 63/684,220, filed on Aug. 16, 2024.

(51) Int. Cl. A63B 69/40; A63B 24/00; A63B 69/38; G05D 1/244; G05D 105/60; G05D 107/20

(52) U.S. Cl. CPC A63B 69/406; A63B 24/0003; A63B 69/38; G05D 1/244; A63B 2220/05; A63B 2220/806; A63B 2225/50; G05D 2105/60; G05D 2107/24

(57) ABSTRACT

An AI-assisted mobile tennis training system integrates a motorized ball delivery device, multi-camera vision, autonomous navigation, and artificial intelligence for adaptive, data-driven player development. The device includes a motorized chassis, ball hopper, programmable ball delivery mechanism with variable spin, speed, and trajectory control, and a navigation subsystem employing omnidirectional wheels and localization based on court line recognition. A multi-camera array captures real-time player and ball movement, while onboard and remote computing modules process the data to determine player position, shot type, and performance metrics. An AI model predicts optimal ball delivery parameters and adapts drills based on player progress. A mobile application provides remote control, drill customization, and performance analytics. The system supports autonomous repositioning, safety monitoring, and individualized training plans, enabling dynamic, responsive, and efficient tennis practice for skill acquisition and improvement in both amateur and professional players.

### CROSS-REFERENCE TO RELATED APPLICATIONS

This application claims priority under 35 U.S.C. § 119(e) to U.S. Provisional Patent Application No. 63/684,220 , filed Aug. 16, 2024, entitled “Tennis Training System”, the entirety of which is hereby incorporated by reference.

### TECHNICAL FIELD

The present disclosure relates generally to sports training equipment and methods, and more particularly to automated ball delivery systems for tennis and similar racket sports. In certain embodiments, the disclosure relates to an AI-enabled, mobile tennis ball feeder and training platform incorporating multi-camera tracking, autonomous navigation, adaptive targeting, and integrated performance analytics.

### BACKGROUND

Conventional tennis ball feeders and practice machines are typically stationary devices capable of launching balls at pre-set intervals, speeds, and trajectories. While these devices are effective for repetitive drills, they lack the ability to dynamically adapt to a player's performance, to reposition themselves on the court, or to integrate advanced analytics into training sessions. Most existing systems require manual relocation by the user, offer limited targeting accuracy, and do not leverage real-time feedback from player tracking or ball trajectory monitoring.

In competitive and high-performance training, coaches and athletes benefit from drills that closely simulate match conditions. Such drills may require rapid variation in shot placement, speed, and spin, and may need to respond to live play or evolving practice objectives. Current solutions lack robust autonomy, fine-grained targeting control, and comprehensive integration with analytics systems, limiting their ability to provide individualized, adaptive training regimens.

Furthermore, while computer vision and AI-based player analysis technologies are increasingly used in professional sports, these capabilities are rarely integrated directly into portable, on-court ball delivery systems. This gap in technology results in missed opportunities to generate tailored training programs that respond to observed performance in real time, as well as to collect and archive session data for longitudinal performance tracking.

### SUMMARY

In various embodiments, the present disclosure provides a mobile tennis ball feeder and training system that incorporates autonomous navigation, multi-camera visual tracking, AI-enabled performance analytics, and adaptive drill generation capabilities. The system may comprise a motorized chassis supporting a ball hopper, a programmable ball delivery mechanism, and a plurality of imaging devices mounted to capture both player movement and ball trajectories.

A navigation subsystem, in communication with the ball delivery control unit, enables the system to move autonomously about the court according to predefined or dynamically generated paths. Integrated computer vision modules process multi-camera input to identify player position, movement patterns, and shot characteristics, as well as to monitor the location and bounce points of delivered balls. Based on this analysis, the system automatically adjusts delivery parameters such as ball speed, spin, trajectory, and targeting location.

In some embodiments, the AI analytics engine generates a customized training program that evolves in real time, incorporating feedback from each shot to modify subsequent feeds. The system may further display session metrics, performance trends, and recommended adjustments to the player or coach via a connected user interface. The platform can store performance data for later review, enabling longitudinal tracking and objective measurement of skill development.

By combining mobile autonomy, intelligent targeting, and integrated analytics in a single platform, the disclosed system addresses limitations of prior art devices, providing a highly adaptable, data-driven training tool for players of all levels.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the invention may be utilized, and the accompanying drawings of which:

FIG. 1 is a side elevation view of the ball feeder and delivery system with the outer shell removed, showing the internal frame, throwing assembly, hopper, and feed control components.

FIG. 2 is an opposite side elevation view of the system with the shell removed, illustrating the drive train, electronics compartment, and redundant sensing arrangement.

FIG. 3 is a side elevation view of the system with the outer shell in place.

FIG. 4 is an opposite side elevation view of the system with the outer shell in place.

FIG. 5 is a front elevation view of the system with the shell removed, showing the dual wheel throwing assembly and feed chute.

FIG. 6 is a back elevation view of the system with the shell removed.

FIG. 7 is a front elevation view of the system with the shell in place.

FIG. 8 is a back elevation view of the system with the shell in place.

FIG. 9 is a top elevation view of the system with the shell in place.

FIG. 10 is a bottom elevation view of the system with the shell in place.

FIG. 11 is a perspective view of the system without the outer shell.

FIG. 12 is a perspective view of the system with the outer shell in place.

FIG. 13 is a perspective view of a custom battery pack for the system.

FIG. 14 is a perspective view of an integrated hub motor Mecanum wheel for the system.

FIG. 15 is a schematic view of a camera mounted with a 20-degree downward tilt.

FIG. 16 is a schematic view of a camera mounted with a 7-degree downward tilt.

FIG. 17 is a perspective view of a camera with a transparent housing, revealing internal components.

FIG. 18 is a top view of the camera assembly with the transparent housing in place.

FIG. 19 is a bottom view of the camera assembly with the transparent housing in place.

FIG. 20 is a perspective view of the camera assembly with an opaque housing in place.

FIG. 21 is a block flow diagram of the electrical supply specification for the system.

FIG. 22 is a block flow diagram of the camera system in communication with the processing system.

FIG. 23 is a screenshot of the AI-enabled navigation interface showing device position and pathing.

FIG. 24 is a screenshot of the AI-enabled targeting interface showing programmed target zones.

FIG. 25 is a screenshot of the AI-enabled ball tracking interface with trajectory overlays.

FIG. 26 is a screenshot of the shot and form analysis interface with video-to-text output.

FIG. 27 is a screenshot of the virtual training simulation interface.

FIG. 28 is a screenshot of the AI-generated drill configuration interface.

FIG. 29 is a block diagram of the communications and processing architecture of the system.

FIG. 30 is a block flow diagram of methods for automated generation of a customized training program.

FIG. 31 is a block flow diagram of AI-enabled adaptive training program generation.

FIG. 32 is a block diagram of an example computing machine for implementing system functions.

### OVERVIEW

The disclosed AI enabled tennis training system is designed to modernize the way individuals practice and improve their tennis skills. This system combines an array of cameras and sensors to mimic the perception capabilities of autonomous driving technologies, offering a comprehensive training experience that includes drills with automated metrics, swing analysis, and interactive ball feeding. Accompanied by a companion mobile app, the system allows for voice interaction, pre-programmed games, and player skill detection to customize the training experience to each user's level.

In addition to serving as a highly advanced ball machine, the system also acts as a fitness tool, providing full guided workouts with professional instruction tailored to various skill and fitness levels. This system is aimed at a broad spectrum of users, from those seeking a fun and energetic addition to their fitness routine to competitive players and coaches looking for precise, data-driven insights into performance and improvement.

### Dispenser and Feeder

The dispenser and feeder system includes a sophisticated design that controls the speed, spin, and height trajectory of each ball delivered.

The dispenser component of the system uses a stepper motor for precise control and quiet operation. It incorporates a mechanical button to detect the presence of balls loaded in the carousel, ensuring a reliable supply of balls to the feeding mechanism. A time-of-flight sensor was used in previous versions to detect the presence of balls, and may be considered in the future. The hopper is capable of holding up to 200 balls, providing ample capacity for extended training sessions without the need for frequent reloading.

Once the balls are dropped from the dispenser into the “throwing” portion of the feeding system, the precise servo motor design takes over. The speed of the ball is controlled by the RPM of the throwing motor wheels, ensuring consistent and accurate propulsion. The spin of the ball is adjusted by the relative motion of the wheels: the top wheel spinning faster creates top spin, while the bottom wheel spinning faster creates slice. The height trajectory, which governs the angle of launch, is managed by adjusting the elevation of the throwing mechanism.

### Camera System

The camera unit in the AI enabled tennis training system is a critical component designed to capture high-resolution footage of the tennis court, player, and ball movements, thereby enabling advanced analysis and training capabilities. Preferably comprising four IP based cameras, the system provides comprehensive visual data that mimics the perception capabilities of autonomous driving technologies. It is also contemplated that more or fewer than four cameras could be utilized to the same effect in the training system. The primary camera array comprises three equidistant cameras with 120-degree field-of-view (FOV). To optimize their effectiveness, all of these cameras are angled downward at 20 degrees, reducing wasted pixels capturing the ceiling.

In addition to the primary array, there is a single camera with a 90 degree FOV (zoomed) lens facing directly forward. This camera serves the purpose of capturing detailed motion of players on the far court. It can be assumed that the ball machine will consistently face the approximate center of the opposite court for ball feeding. The zoomed camera is strategically tilted down by 7 degrees vertically.

These cameras are tightly integrated with a hardware system that receives images from the camera system. An example of suitable hardware used in the AI enabled training system is Nvidia Jetson hardware. Processing of the images via suitable hardware ensures seamless data processing and high-speed performance through the use of ethernet connectivity. The strategic placement and protective mounting within a specially designed enclosure optimize visibility and ensures the cameras are well-protected while allowing for easy adjustments and maintenance.

The primary purpose of the camera system is to gather detailed visual data that feeds into the training system's AI enable analytics. The camera system further determines where the machine is located. This data is crucial for tracking ball trajectories, player movements, and swing mechanics, providing real-time feedback and actionable insights to the user.

By capturing every angle and nuance of the game, the cameras enable precise monitoring and analysis, allowing for personalized training programs tailored to each player's skill level. This system not only enhances the effectiveness of training drills but also contributes to the development of interactive and engaging training content, making the tennis training system a comprehensive tool for improving tennis skills and overall fitness.

### Wheel System

The wheel system of the tennis training system is a crucial component that provides the mobility and flexibility required for advanced tennis training. In an example, the wheel system features motorized Mecanum wheels, enabling the device to move omnidirectionally with precision and ease. Each of the four Mecanum wheels is powered by a dedicated motor, allowing for sophisticated movements such as forward, backward, sideways, and diagonal navigation without the need to turn. This advanced mobility allows the device to quickly reposition itself and smoothly transition across the court. Additionally, the wheels facilitate clockwise and counterclockwise rotation, replicating the “spread angle” feature for dynamic ball delivery direction adjustments.

The wheel system supports both automated and manual control modes, enabling a variety of functionalities. During automated operation, the device's AI and sensors enable accurate navigation and positioning, allowing it to execute multi-step drills seamlessly. For example, the tennis training system can start with warm-up drills on the short court and autonomously move back to full court drills without user intervention. The system can also operate via passive pushing or motorized assisted pushing, providing flexibility for setup and adjustments. The system may be moved autonomously, manually via the app, or the wheels may be disabled, and they are then “freewheel” based, enabling the system to be pushed. The system may also be controlled by the user through a Bluetooth Xbox controller.

The motorized Mecanum wheels offer enhanced mobility, precision positioning, and increased stability compared to traditional wheel designs. This design ensures the device remains stable during movement and ball delivery, reducing the risk of tipping or misalignment. Overall, the wheel system significantly enhances the tennis training system's mobility and control, providing the versatility needed for effective and efficient tennis training. This advanced mobility solution allows the device to navigate and operate seamlessly on the court, adapting to various training scenarios and player needs, ultimately delivering a consistent and high-quality training experience.

While Mecanum wheels are described as one example of wheels that are suitable for use with the tennis training system, it is contemplated that other wheel designs, types or brands may be used with the system to the same effect.

### Electrical System

The electrical system of the tennis training system is designed to ensure robust and efficient power management for all components. By way of example only, the system may use a rechargeable battery system using Lithium Iron Phosphate (LiFePO4) technology, known for its safety, long cycle life, and stable performance. For example only, a 60V20Ah battery may be used.

The battery can be easily recharged via a standard AC outlet, allowing for quick and convenient powering up between training sessions. Additionally, the electrical system incorporates active cooling mechanisms to maintain optimal operating temperatures for all electronic components, preventing overheating and ensuring consistent performance even in hot weather conditions. It is further contemplated that other power and electrical systems may be used with the system to the same effect.

### Computer System

The AI enabled tennis training system further includes a computer system. By way of example, the computer system may be the Jetson AGX Orin or Jetson Orin Nano Super, high-performance computing platforms chosen for advanced AI capabilities and compatibility with the device's machine vision cameras. This powerful processor enables real-time data processing and analysis, which is critical for the device's sophisticated training programs. The system may include an external touchscreen, providing a user-friendly interface for controlling the device, setting up training programs, adjusting settings, and monitoring performance metrics in real-time. Preferably, however, the system is controlled by a mobile application on a user's device.

To enhance the user experience, the computer system is equipped with speakers, allowing for audio feedback and instructions during training sessions. This combination of advanced processing power, intuitive interface, and audio support ensures that the tennis training system delivers a comprehensive and engaging training experience.

### Software Architecture

A plurality of cameras, disclosed herein by way of example as four cameras, may be positioned to capture comprehensive visual data of the tennis court, player, and ball movements. These cameras feed visual data into the Jetson platform via Gstreamer, a multimedia framework that handles the streaming of video data efficiently.

### Jetson Platform

At the core of the system is the Jetson AGX Orin or Jetson Orin Nano Super, which handles multiple critical functions, as described below.
Onboard Agent: This component manages the interaction between the hardware and the software, ensuring smooth operation and coordination of tasks.
Web Application: Provides a user interface accessible via a web browser, allowing users to control and monitor the device remotely.
Nvidia Triton Inference Server: Responsible for running AI models and processing the data captured by the cameras, enabling real-time analytics and feedback.
K3S: A lightweight Kubernetes distribution used for managing containerized applications within the system.
Hardware Drivers: These ensure proper communication and control of the various hardware components, such as motors and sensors.

### Data and Control Interface

Data from the Jetson platform is transmitted to a mobile device, which acts as a controller. The mobile device is responsible for:
Auth: Authentication to ensure secure access to the system.
Controller: Manages the control commands sent to the Jetson platform for operating the training programs and device movements.
Data Visualizer: Provides visual representation of the data collected, such as performance metrics and analytics.

This architecture diagram showcases the sophisticated integration of hardware and software within the AI enabled tennis training system. The cameras capture detailed visual data, which is processed by the Jetson platform to provide real-time analytics and feedback. The system's control and monitoring functions are managed via a mobile device, with additional support for audio and wearable integration to enhance the overall training experience.

### Mobile Application

A mobile application serves as a central interface for controlling the ball machine, selecting training drills, storing player data, and monitoring performance metrics. Unlike other training systems that rely heavily on onboard touchscreens, the training system disclosed herein is primarily controlled through this mobile app, providing a seamless and user-friendly experience for players.

### Controller Functions One of the primary functions of the app is to act as a remote controller for the ball machine. Key features include:

Pairing: The app pairs with the ball machine via a NFC or QR code displayed on the machine's touchscreen, or via a Bluetooth connection, ensuring accurate and secure connections even in environments with multiple devices.
Manual Feeding/Drill Builder: Users can manually control the ball feeding, setting parameters such as speed, spin, height, and location. This feature is particularly useful for professional coaches working on specific shots with students. It also serves as a “drill builder,” allowing users to create custom drills without predefined content.
Summon: The app can send commands to the ball machine to move to specific locations on the court, such as the back center of the baseline or the net post, and return to the charging station, similar to a smart summon feature in autonomous vehicles.

### Settings

The app offers various settings to customize the ball machine's operation: enable or disable wheels; set maximum driving and feeding speeds; enable video recording for performance analysis; receive alerts when the ball supply is low; password protection and other security features.

### Drills and Skill Tree

Drills are the primary method of interaction with the ball machine, with predefined routines guiding the training sessions. The app features:
Just Hit: An easy-to-start mode that adjusts the pace and difficulty based on the player's performance, ideal for warm-ups.
Skill Tree: A structured progression of drills organized around specific skills, such as backhand techniques or net play, using a gamified approach to encourage continuous improvement. The skill tree includes various types of shots and movement drills, each designed to progressively challenge the player.

### Metrics

The app tracks a wide range of metrics to help players understand and improve their game:
Tennis Metrics: Includes shot selection, placement, accuracy, pace, and location, providing detailed insights into performance.
Health Metrics: Integrates with health ecosystems to track steps, calories burned, distance moved, and shot count, giving players a comprehensive view of their physical activity during training sessions.

The mobile application is a powerful tool that enhances the user experience by providing comprehensive control over the ball machine, customizable training drills, and detailed performance metrics, all accessible from a convenient mobile interface.

### Artificial Intelligence

### Navigation System

The tennis training system features an advanced AI navigation system that ensures precise movement and positioning on the tennis court, enhancing the training experience for users. The navigation system utilizes a neural network model (EfficientNetV2) that processes multiple camera views as input and outputs the device's position (x, y) and orientation (rotation). The model is trained on a dataset of time-synchronized frames captured simultaneously from each camera. These frames are manually annotated to identify court keypoints—specific intersection points of tennis court lines with well-known, standardized locations. Using camera calibration parameters (intrinsics and extrinsics) and these annotated keypoint locations, the system computes the pose of each camera in 3D court space via OpenCV. Multiple camera pose estimates are averaged to determine the “center of gravity” of the camera stand, establishing the precise position of the device. Training is performed using the PyTorch framework with thousands of synchronized, annotated images paired with computed location data. This method allows the device to accurately determine its position on any standardized tennis court, making the system universally applicable and highly reliable in varied training environments.

The wheel system described above, which may utilize Mecanum wheels, enables the system, in particular, the ball device, to move omnidirectionally, providing the flexibility to navigate in any direction with ease. This is complemented by visual positioning feedback that continuously monitors and adjusts the device's movement to maintain accuracy. Rotational alignment is also managed using the localization model, ensuring the device is always correctly oriented for optimal ball delivery.

Safety is a paramount consideration, and the system includes features to prevent movement when people are nearby, ensuring that the device operates safely during training sessions. Additionally, the navigation system incorporates sophisticated pathfinding and route planning algorithms, allowing the tennis training system to autonomously plan and execute efficient routes across the court. This capability enables the device to transition seamlessly between different training drills, starting from warm-up positions to more complex full-court drills, without requiring user intervention.

Overall, the disclosed navigation system combines neural network-based localization, versatile movement capabilities, and robust safety measures to deliver a dynamic and user-friendly tennis training experience.

### Targeting System

The tennis training system features an advanced AI targeting system that significantly enhances the precision and adaptability of ball delivery during training sessions. This system utilizes a neural network to predict the distance a tennis ball will travel based on the motor configuration, specifically considering the speed, spin, and height parameters set by the device.

The targeting system employs numerical optimization in conjunction with the neural network to ensure that the speed, spin, and height are bounded within valid ranges for any given target location on the court. This model focuses on the first bounce of the tennis ball, ensuring that it lands precisely where intended. For example, if the user selects a soft warm-up drill, the system will limit the speed of the ball and adjust the height to compensate, ensuring the ball still reaches the desired location gently.

The targeting system also allows drills to be programmed with approximate desired characteristics such as speed, spin, or height, while still ensuring the ball lands at the specified point on the court. This flexibility enables a wide variety of training scenarios, from gentle warm-ups to intense, high-speed drills, all tailored to the player's needs and skill level.

Data collected from empirical testing—real-world trials of ball delivery under various conditions—are used to train the neural network. This extensive dataset ensures the predictions made by the neural network are accurate and reliable, reflecting the actual performance of the ball machine under diverse conditions.

The combination of neural network predictions and numerical optimization not only guarantees precise targeting but also allows for dynamic adjustments based on the specific requirements of each drill. This sophisticated system ensures that players receive the most effective and tailored training experience possible, enhancing their skills through precisely controlled and accurately delivered ball placements.

### Ball Tracking System

The ball tracking system in the tennis training system is a sophisticated component designed to ensure precise and reliable tracking of tennis balls during training sessions. Leveraging a neural network with semantic segmentation and heat maps, the system accurately determines the ball's location in each frame. Semantic segmentation allows the network to distinguish the ball from other objects, while heat maps highlight the most probable areas where the ball is located.

To enhance accuracy, the system uses multiple camera perspectives and ray tracing techniques to triangulate the ball's position in 3D space. This multi-angle approach not only improves detection precision but also enables the system to call balls in or out, providing valuable real-time feedback during practice sessions. By comparing the bounce location of the ball with the intended target, the system can assess the accuracy of each shot, offering detailed insights into a player's performance.

The tracking process begins by assigning a new identifier to each detected ball if no previous balls have been tracked. As the frames progress, the system matches new detections with existing Ball Tracks in memory. This involves calculating the Euclidean distance between the last known positions of tracked balls and the current detections, adjusting for any temporal discrepancies. Using an optimized assignment algorithm, the system ensures that each ball is accurately tracked from frame to frame, even amidst fast-paced play.

By maintaining continuous and precise tracking, the tennis training system's ball tracking system provides comprehensive analytics on shot placement and dynamic play. This data is crucial for players and coaches to understand performance trends and identify areas for improvement, ultimately enhancing the effectiveness of training sessions. The integration of advanced neural network techniques and efficient tracking algorithms ensures that the system delivers high-level accuracy and reliability, making it an invaluable tool for tennis training.

### Shot and Form Analysis

The tennis training system includes an advanced Shot and Form Analysis system that leverages a sophisticated neural network architecture designed to interpret and describe player actions and shot characteristics through a video-to-language framework. This architecture enables the system to generate rich, expressive descriptions of each shot without being constrained by a rigid ontology, providing nuanced and detailed insights into player performance.

The neural network processes video input and pairs it with descriptive language, resulting in detailed narratives such as “loopy western forehand hit deep in the court and off the back foot with a lot of topspin” or “hitting the ball late due to lengthy take back of the swing.” These descriptions provide a comprehensive understanding of the player's technique and any issues that may arise, such as the timing and mechanics of their swings.

Text descriptions generated by the neural network are distilled into rich metadata, which is then used in detailed analytics. This metadata allows for in-depth analysis of shot types, subtypes, and their respective accuracies. For instance, the system can track the accuracy of specific shots, such as comparing “one-handed backhand slices down the line” with “one-handed backhand topspin shots down the line,”revealing trends and areas for improvement.

These analytic capabilities are particularly valuable for identifying patterns and performance trends over time. By saving this data historically, the system enables comprehensive player trend analysis, allowing coaches and players to track progress, identify recurring issues, and adjust training programs accordingly. For example, if a player consistently struggles with accuracy on one-handed backhand slices down the line, the system will highlight this trend, prompting targeted drills to improve this specific aspect of their game.

Overall, the Shot and Form Analysis system provides a robust framework for understanding and improving player performance through detailed video analysis and expressive language descriptions, leading to more effective and personalized training programs.

### Simulation

The tennis training system described herein provides a simulation experience, developed using Godot, three. js, and Nividia Omniverse, for example, serves multiple critical purposes in expediting the product development process for the tennis training system. This simulation acts as a digital twin of the ball machine, enabling the execution of tasks that are essential for refining the hardware and software of the device.

### Sensor Placement and Design

The simulation assists in optimizing sensor placement and specifications. The simulation helps validate whether this configuration is optimal by testing different sensor placements and configurations in a virtual environment.

### Machine Learning Data Collection

The simulation environment is crucial for unblocking machine learning efforts by providing simulated datasets with perfect ground truth. This includes time-synchronized images and point clouds from simulated camera and LiDAR sensors, along with the precise positions of the ball, player pose, and machine in 3D space. This synthetic data is essential for training machine learning models before real-world data collection begins, ensuring that the AI subsystems are robust and well-prepared for deployment.

### User Experience Prototyping

The simulation environment allows the tennis training system to prototype and refine the user experience before the hardware is fully developed. This includes testing voice interaction patterns, sequencing tasks in drills and games, setting player achievement thresholds, and handling failure states and exceptional conditions. By using virtual reality, the AI enabled tennis training system can create an immersive and interactive user experience, similar to first-person tennis games, which can be iterated quickly and effectively.

### Simulation of Subsystems

The digital twin simulation encompasses various subsystems, each with specific requirements:
Cameras: Emulates the camera array setup, streaming four video feeds using standard protocols like WebRTC or RTSP.
Throw Motors: Simulates the motor settings for height, speed, and spin, incorporating empirical data for realistic performance.
Dispenser: Mirrors the functionality of the ball dispenser with optical sensor checks and synthetic states for ball presence.
Wheels: Simulates the omnidirectional movement capabilities of the Mecanum wheels, allowing realistic navigation and positioning.

### API and Architecture

A proposed API allows for uniform control and feedback between the hardware and the simulation. This ensures seamless interchangeability and facilitates the development of dependent systems such as the On Device Application and AI models. The simulation environment uses HTTP or similar internet-based protocols to communicate, maintaining consistent data formats across both the simulation and actual hardware.

### AI Training and Reinforcement Learning

The simulation collects training data and automates ground truth label pairs alongside the raw data. This capability is invaluable for iterating on AI concepts without the need for extensive real-world data collection. Additionally, the simulation environment supports reinforcement learning, enabling the system to “learn” and refine its targeting and other operational behaviors.

### Performance and Real-time Capability

The simulation also validates the AI's end-to-end sensing and response loop, ensuring real-time capability. This involves monitoring performance to ensure the system can operate efficiently on the Jetson device, which is critical for delivering a responsive and accurate training experience.

By creating a comprehensive simulation environment, the tennis training system accelerates the development and refinement of its tennis training system. This approach ensures that by the time the hardware is fully developed, the software and user experience will be finely tuned, providing a robust, effective, and engaging training tool for tennis players and coaches.

### Example of a Generated Drill

Intermediate: Solo Drill
Forehand: Neutral Ball Drill (Right-Handed Players)
Drill For: Singles and Doubles
Ball Feeder/Delivery Machine: Approximations of height, speed, spin of ball
Desired height over the net from the feed: 3 feet
Desired speed of feed: 30 mph
Spin: None
Player Objective: To hit cross court shots (with roughly 3 feet of net clearance) past the service line.

### Voice Commands

“Start one step behind the baseline and to the right of the hashmark in a ready position”

“Hit cross court shots past the service line with approximately 3 feet of net clearance”

“Recover back to your starting position after you have played your shot”

Number of sets/reps/rest between sets can be adjusted based on users configuration.

Example: 5 sets/15 balls/30 second rest in between sets

The present disclosure further contemplates the following additional features of the AI enabled tennis training system:

### Advanced AI and Machine Learning

Predictive Analytics: Utilize AI to predict player performance trends and potential injury risks. This feature could analyze historical data to forecast future performance and suggest preventive measures or alternative training strategies.
Virtual Coaching Assistant: Develop an AI-driven virtual coach that can provide real-time verbal feedback, suggestions, and encouragement based on the player's performance during training sessions.
Multi-player Synchronization: Allow multiple AI enabled tennis training systems to synchronize and interact, enabling group training sessions and competitive play scenarios with accurate coordination and feedback.

### Connectivity and Integration

Integration with Professional Coaching Platforms: Enable seamless integration with existing coaching platforms and software, allowing coaches to remotely monitor progress, provide feedback, and design custom training programs.
Cloud-based Data Storage and Analysis: Implement cloud storage for training data, enabling players and coaches to access performance metrics, video recordings, and analytics from anywhere.

### User Experience and Accessibility

Voice Command Functionality: Introduce advanced voice recognition to allow users to control the device, start drills, and request feedback without needing to interact physically with the device.
Customizable Training Environments: Use augmented reality (AR) to create customizable virtual training environments. Players can practice in various simulated court settings or compete in virtual tournaments.
Interactive Light and Sound Feedback: Incorporate LED lights and sound systems that provide immediate visual and auditory feedback on shot quality and accuracy, enhancing the sensory training experience.

### Safety and Maintenance

Self-diagnosing and Maintenance Alerts: Implement self-diagnosing capabilities that detect hardware or software issues and provide maintenance alerts or troubleshooting steps to ensure optimal device performance.
Automated Ball Retrieval System: Develop an automated ball retrieval and reloading system that collects balls from the court and reloads the hopper, minimizing interruptions during training sessions.

### Additional Features May Include the Following

Weather Adaptation: Equip the device with sensors to detect weather conditions and adjust training programs accordingly. For instance, modifying drills based on wind speed or humidity to simulate real match conditions.
Social Sharing Features: Enable players to share their performance data, progress, and achievements on social media platforms directly from the mobile application, fostering a community of users and promoting the product.
Alternate Sport Adaptation: Modify the device to accommodate pickleballs, for example, to enable use and training of alternate forms of balls.

### DETAILED DESCRIPTION

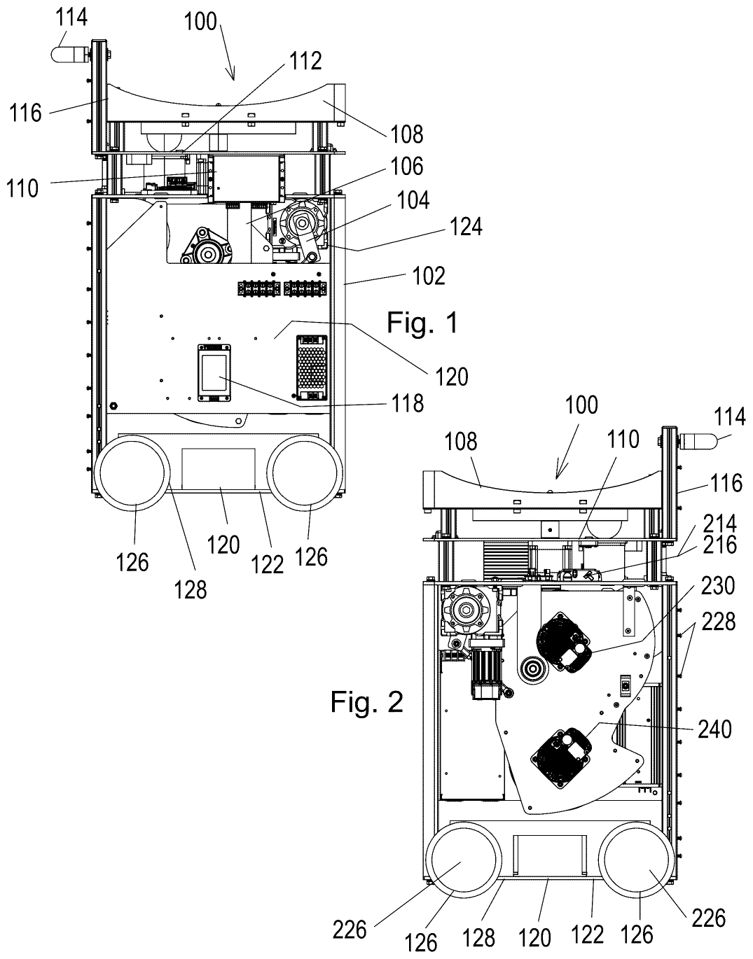

Referring now to FIG. 1, a side elevation view of a ball feeder and delivery system 100 is shown with the outer shell removed. The system includes a rigid square-tube chassis 102 with side rail 120 and lower frame rails 122 supporting a dual-motor throwing assembly 104 mounted via a pair of lateral support arms 106. A worm gearbox 124 is positioned for rotational power transmission to the throwing wheels. A hopper 108 is positioned above the throwing assembly for gravity-fed ball delivery, with an integrated stepper motor dispenser 110 at the hopper base to regulate feed rate. A mechanical button 112 is mounted adjacent to the dispenser to detect ball presence. A rigid push handle 114 is secured to the rear chassis crossmember 116 for manual maneuvering. Power supply units 118 are mounted to a power plate 120 located along the lower frame rails 122. Corner-mounted Mecanum wheel assemblies 126 provide mobility, each assembly being recessed within frame cut-outs 128 to reduce protrusion. Cable harnesses are routed along protective channels to interconnect the various electrical components.

In FIG. 2, an opposite side elevation view of the same ball feeder and delivery system 100 is shown with the shell removed. From this perspective, the worm gearbox 202 is visible, including the direct-drive angle/height motor 204. The hopper 108 is again visible, with a second side-mounted mechanical switch 210 aligned for redundancy in ball detection. A right-side control electronics compartment 212 is mounted on the frame, housing the microcontroller unit 214 and motor driver boards 216. The lower chassis member 218 supports a battery tray 220 configured to receive the removable LiFePO₄ battery pack. The right-side wheel recess (not shown) c0ontains a Mecanum wheel assembly 126, mounted to a direct-drive hub motor 226. A right-side access panel mount 228 is secured to the frame perimeter, allowing future attachment of a protective cover. FIG. 2 further shows the top throw device 230 and the bottom throw device 240, as well as the dispenser motor 250.

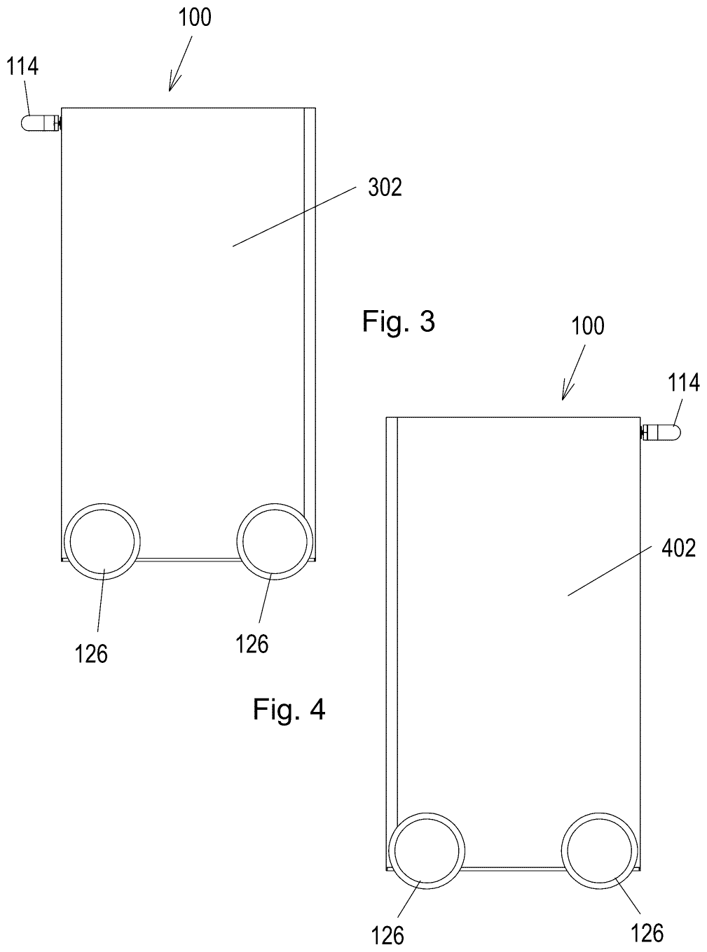

FIG. 3 illustrates a side elevation view of the ball feeder and delivery system 100 with the outer shell 302 in place. The smooth exterior paneling encloses the frame while preserving access to functional ports. Wheel recess openings (not shown) are integrated into the lower portion of the shell 302 to allow clearance for the Mecanum wheels. The integrated push handle housing 108 protrudes slightly from the rear panel to enable manual movement. Fastening points 310 for the shell are distributed along the perimeter, enabling removal for maintenance. The side seam line 312 is arranged to permit separation of the shell into an upper and lower portion, allowing access to internal components without fully disassembling the shell.

FIG. 4 presents the opposite side elevation view with the shell in place. The right-side outer panel 402 is contoured to match the left-side panel while incorporating a right-side wheel recess 404. A side seam line 406 is positioned to align with that of the opposite side, facilitating shell removal. A right-side ventilation grille 408 is incorporated near the electronics compartment to aid in cooling. The handle housing 410 is visible at the rear, with the rear seam 412 providing a separation between the side and rear panels.

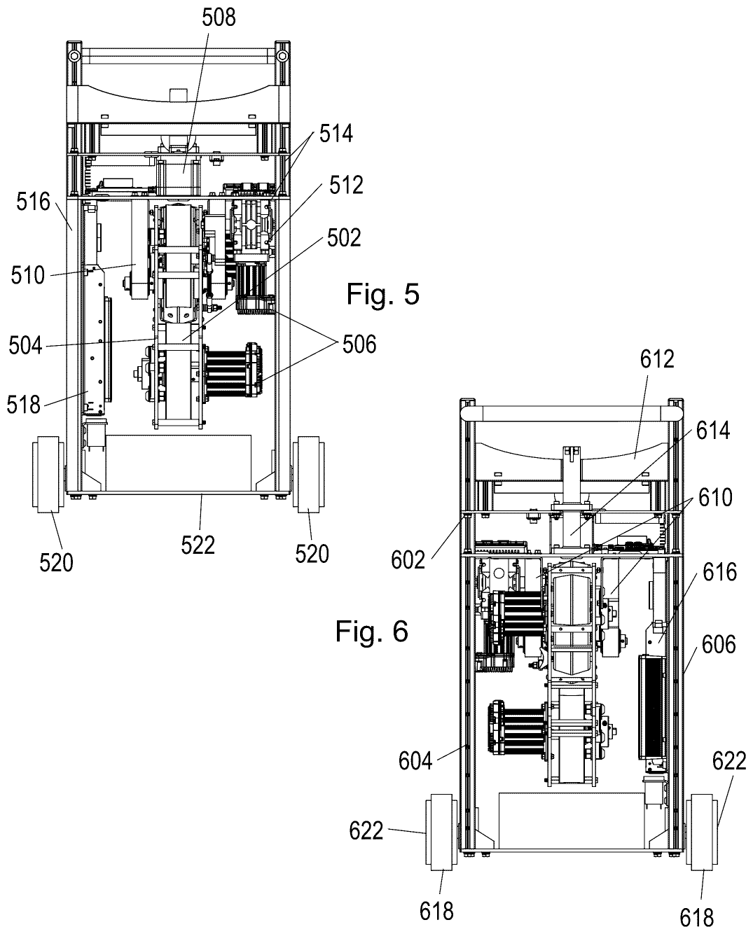

FIG. 5 shows a front elevation view of the ball feeder and delivery system with the shell removed. The dual throwing wheels 502 are mounted within the front frame opening 504, with each wheel driven by an independent motor 506 for adjustable spin control. The ball feed chute 508 directs balls from the hopper into the nip point between the throwing wheels. Upper and lower support brackets 510, 512 hold the throwing wheel assembly rigidly in place. A front crossmember 514 spans between the side frame rails 516, providing structural rigidity. Front-facing sensor housings 518 are mounted above the wheel assembly for trajectory monitoring. The forward wheel assemblies 520 are partially recessed behind the lower frame edge 522. A wiring harness (not shown) for the front sensors and wheel motors is routed along the frame interior for protection.

Referring to FIG. 6, a back elevation view of the ball feeder and delivery system is shown with the shell removed. A rear support frame 602 spans between the left and right chassis rails 604, 606. The dual rear support arms 610 hold the throwing assembly in alignment and counter the cantilever loads during operation. The rear hopper wall 612 is visible, along with the lower hopper discharge port 614 feeding into the throwing assembly. Rear-mounted electronics enclosures 616 house auxiliary control circuits and communication modules. Rear-facing Mecanum wheels 618 are mounted in lower recesses and coupled directly to integrated hub motors 622. Cable harness runs are organized along the interior frame surface, secured with routing brackets (not shown).

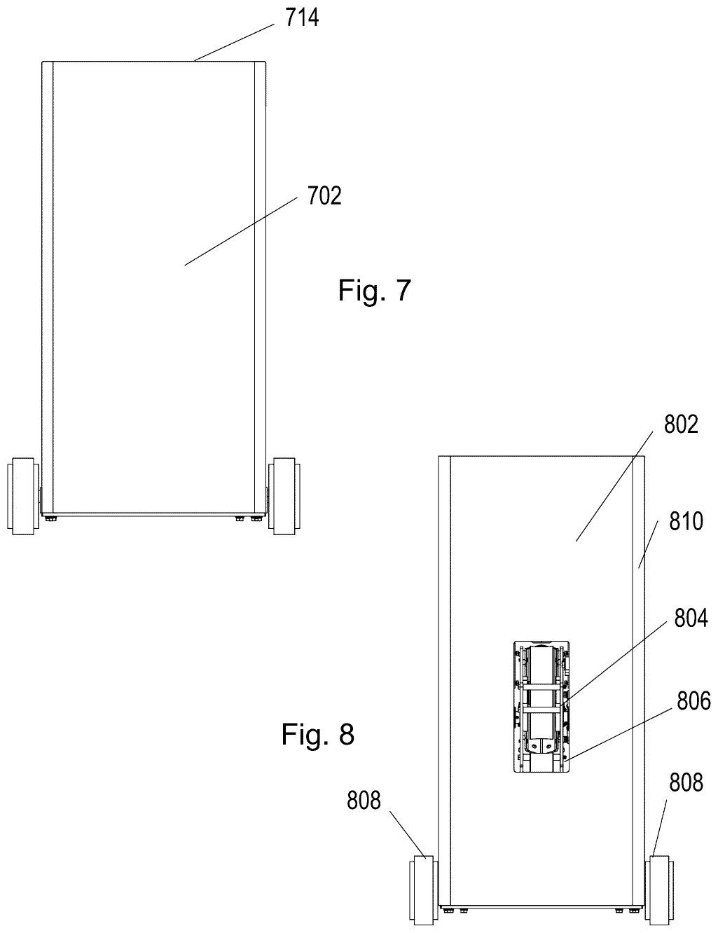

FIG. 7 illustrates a back elevation view of the ball feeder and delivery system with the rear shell 702 in place. The front panel's contour follows the curvature of the wheel recesses (not shown), which provide clearance for the forward Mecanum wheels. The upper shell surface 714 integrates seamlessly with the hopper cover to maintain a smooth exterior appearance.

FIG. 8 shows a front elevation view of the ball feeder and delivery system with the shell in place. The shell panel 802 covers the structural members and internal components. A recessed handle aperture (not shown) is integrated into the upper rear panel for manual movement of the system. The front shell panel 802 encloses the throwing assembly, leaving only the ball launch opening 804 exposed. A recessed panel section 806 surrounds the launch opening to reduce ball rebound and protect internal components. Rear ventilation openings 806 are positioned adjacent to the electronics compartment for airflow. Wheel recess contours 808 match the geometry of the Mecanum wheel assemblies. The seam line 810 between the rear panel and side panels is aligned with the side seam lines for consistent disassembly access.

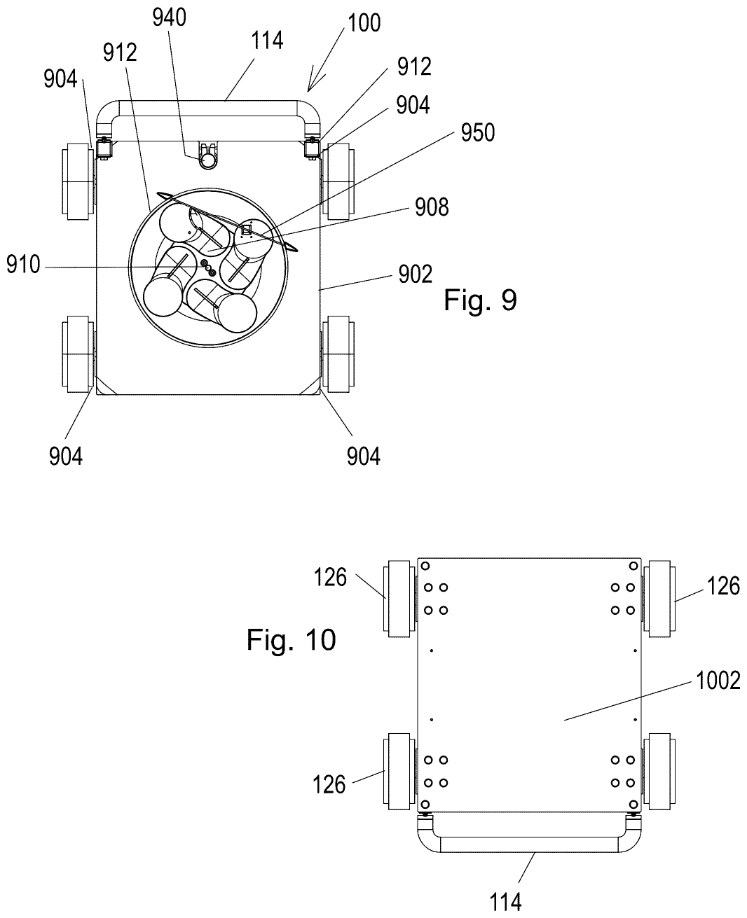

FIG. 9 presents a top elevation view of the ball feeder and delivery system 100 with the shell removed. The top chassis plate 902 includes corner wheel cut-outs 904. The hopper opening 908 is centrally located, and includes a mounting flange 910 for secure attachment. A ball detector 950 is positioned within the hopper opening 908. Handle-mount holes are positioned at the rear of the top plate 902, allowing for handle 114 installation or removal. Internal cable routing channels are arranged along the plate edges to prevent interference with moving parts. The top chassis plate further includes a camera pole mount 940 for receiving a camera pole (not shown).

FIG. 10 depicts a bottom elevation view of the ball feeder and delivery system 100 with the shell removed. Protective skid plates (not shown) may be mounted along the bottom edges to reduce wear during movement over rough surfaces.

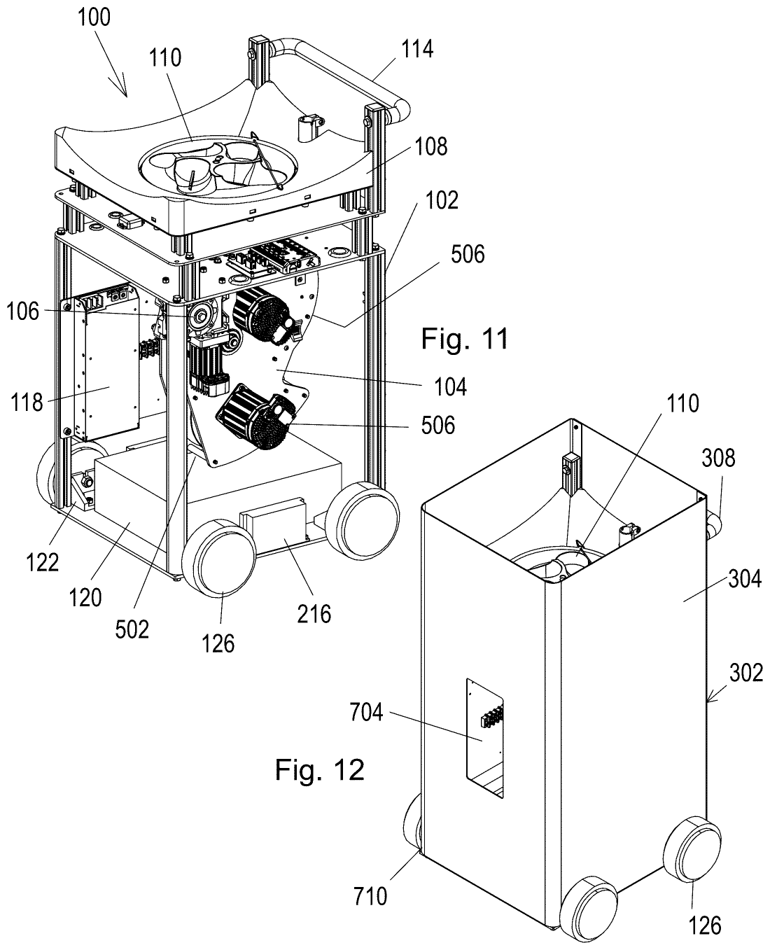

FIG. 11 shows a perspective view of the ball feeder and delivery system without the outer shell. The rigid square-tube chassis 102 carries the dual-motor throwing assembly 104 via lateral support arms 106. The hopper 108 with integrated stepper-motor dispenser 110 and time-of-flight sensor 112 is mounted above the throwing assembly for gravity feed. Cable harnesses rerouted through protective channels and secured by routing brackets (not shown) to avoid moving components. Corner Mecanum wheel assemblies 126 with integrated hub motors 226 reside in recesses 128 to minimize overall width. The rear push handle 114 couples to the rear chassis crossmember 116 for manual maneuvering. A power plate 120 on the lower frame rails 122 supports the power supply units 118 and motor drivers 216. The front frame opening 504 provides access to dual throwing wheels 502 driven by motors 506 through couplings or independent speed control and spin generation.

FIG. 12 illustrates a perspective view of the system with the outer shell 302 installed is shown. Smooth exterior paneling 304 encloses the structural frame while preserving access to ports, ventilation grilles adjacent the electronics compartment (not shown), and a recessed launch opening 704. Wheel recess contours 710 provide clearance for the forward Mecanum wheels 520. The handle housing 308 projects from the rear panel to enable manual transport. Fastening points around seam lines permit removal of upper and lower shell portions for service without full disassembly.

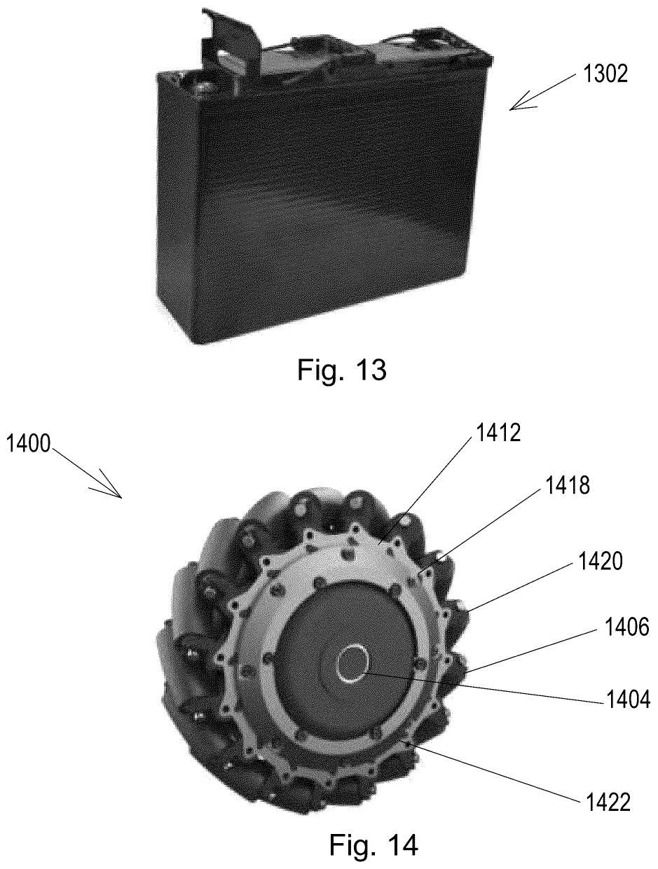

FIG. 13 shows an example of a custom rechargeable battery pack 1302 suitable for powering the electrical system is shown removed from the chassis. The pack 1302 preferably uses Lithium-Iron-Phosphate cells arranged in a series-parallel configuration sized, for example, at 60V20Ah for long cycle life and thermal stability. A battery management system BMS monitors cell voltages and temperatures and provides pack-level protections. A high-current DC connector mates with the chassis-mounted power plate 120. An integrated charge port and state-of-charge indicator LEDs facilitate charging and status checks. A molded hand-grip and keyed mounting rails interface with the battery tray 220 to enable tool-less insertion and removal. Thermal pads couple the cell stack to the pack shell to improve heat transfer. A service-replaceable main fuse provides over-current protection.

FIG. 14 depicts an integrated hub-motor Mecanum wheel 1400*. The hub motor rotor 1404 and stator 1406 are concentric within a sealed hub 1422 that includes a position encoder (not shown) for closed-loop control. The rim 1418 carries a circumferential set of angled rollers 1412. The rollers are oriented at approximately 45 degrees to enable omnidirectional motion and holonomic rotation when used in a four-wheel configuration. A replaceable tread 1420 improves grip on court surfaces. Wheel fasteners interface with the chassis wheel mounts within recesses 128.

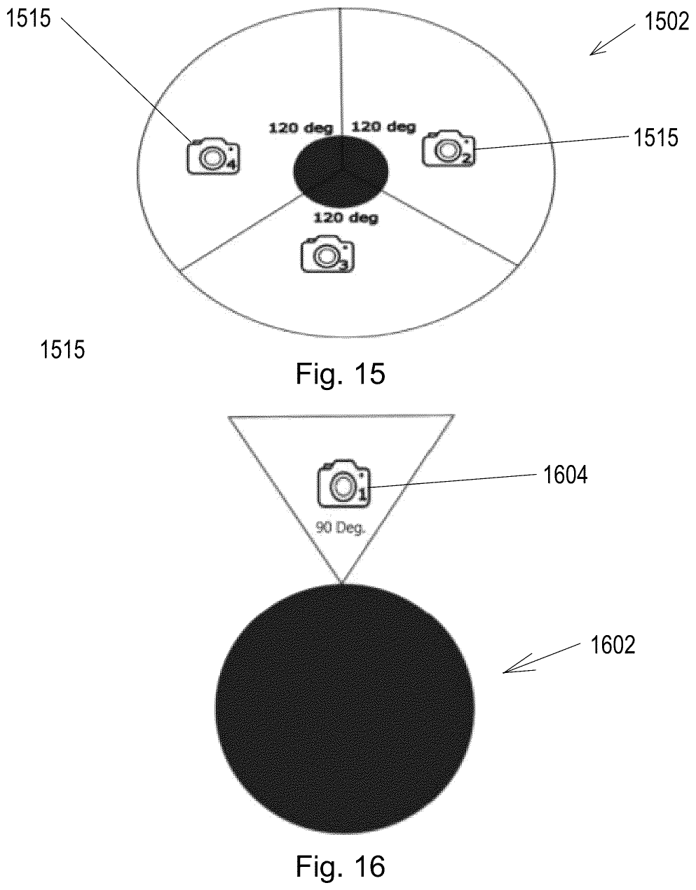

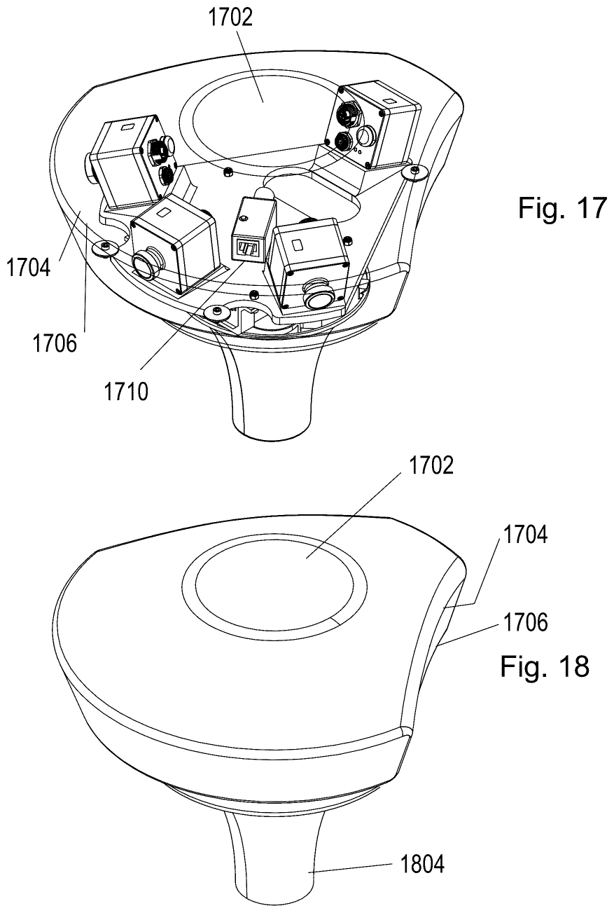

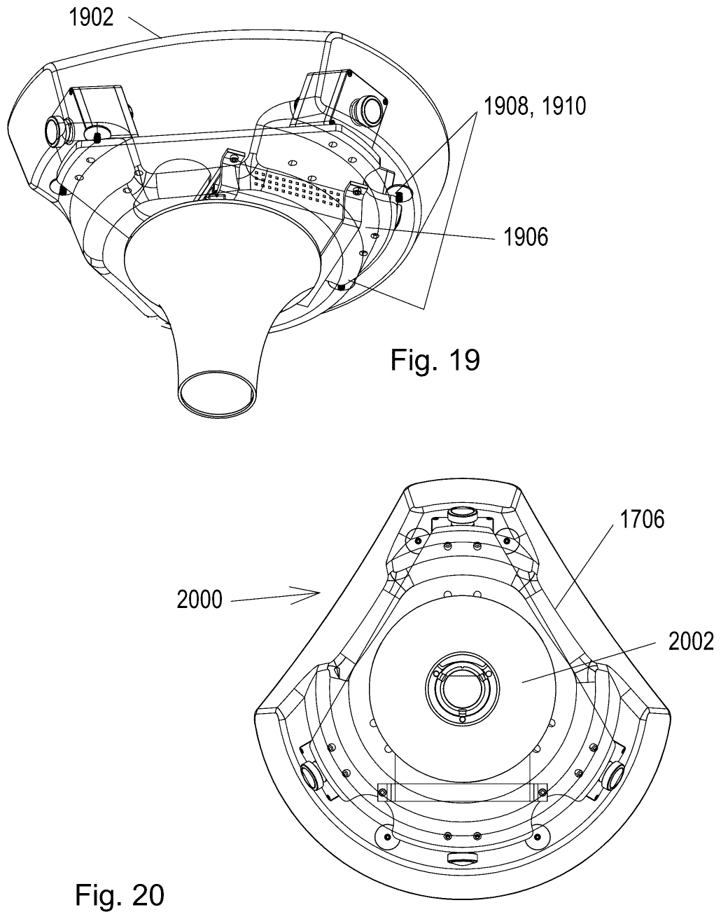

FIG. 15 is a schematic view of a wide-FOV camera module 1502 with three cameras 1515 mounted with a 20-degree downward tilt relative to horizontal. As shown in FIGS. 17 and 19, a lens assembly couples to an imaging sensor PCB inside a protective bracket. A wedge mount establishes the 20-degree inclination to reduce sky/ceiling pixels and concentrate field of view on the playing surface. A sealed cable gland routes Ethernet for PoE supply and data.

FIG. 16 a schematic view of a forward-facing zoom camera 1602 with a 90-degree FOV lens 1604 mounted with a 7-degree downward tilt, again, with reference to FIGS. 17 and 19, The camera 1602 provides detailed imaging of players and ball flight on the far court, complementing the three wide-FOV cameras 1502. A stabilized mount minimizes vibration from the throwing assembly 104.

FIG. 17 a perspective view of a camera assembly within a housing is shown. The top piece of the enclosure 1702 seals to a base ring 1706 with a gasket 1704 to provide environmental protection. The enclosure 1702 permits visual inspection of camera orientation while protecting optics from ball strikes. A PoE interface 1710 is positioned within the housing.

FIG. 18 a top plan view of the camera assembly shows the camera with the cover in place arranged on the base ring 1706, and a cable passage 1804.

FIG. 19 is a bottom view of the camera assembly shows a gasket groove 1902, and an internal EMI shield 1906 that reduces radiated emissions from the camera PCB. Fastener holes 1908 and an alignment key 1910 mate with the chassis bracket for repeatable removal and replacement.

FIG. 20 is top perspective view 2000 of the camera assembly with an opaque housing is shown. An opaque cap 2002 reduces glare and stray light for high-contrast imaging in outdoor use. The cap 2002 attaches to the same base ring 1706 used for the camera assembly 1702, enabling interchangeable housings.

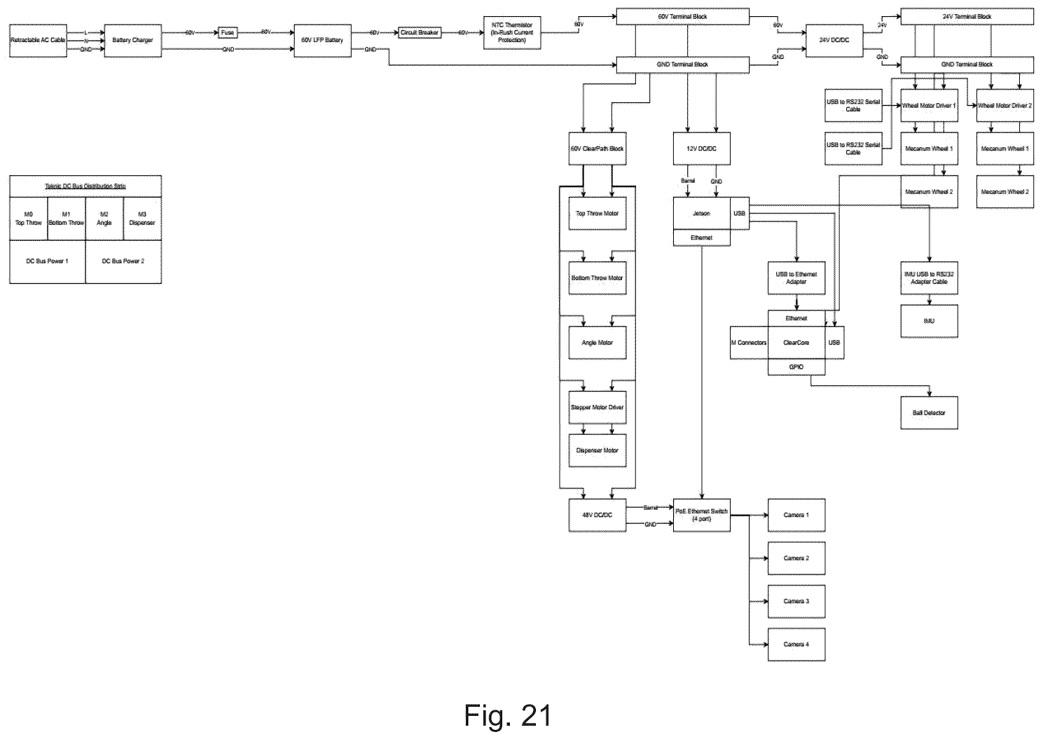

FIG. 21 a block diagram 2100 of the electrical power subsystem is shown. The removable LiFePO4 battery pack provides a DC input to a main power switch and contactor. A battery management system supervises pack health. A protected DC bus feeds wheel motor drivers, dual throwing-motor ESCs, and auxiliary converters that derive regulated rails for logic and peripherals, for example 24V, 12V, and 5V. An onboard charger interfaces to an external AC source. Cooling fans and temperature sensors are controlled by the microcontroller unit for thermal management. An emergency-stop circuit removes power from high-energy loads while maintaining power to the controller for fault logging. Fuses and resettable breakers provide branch protection.

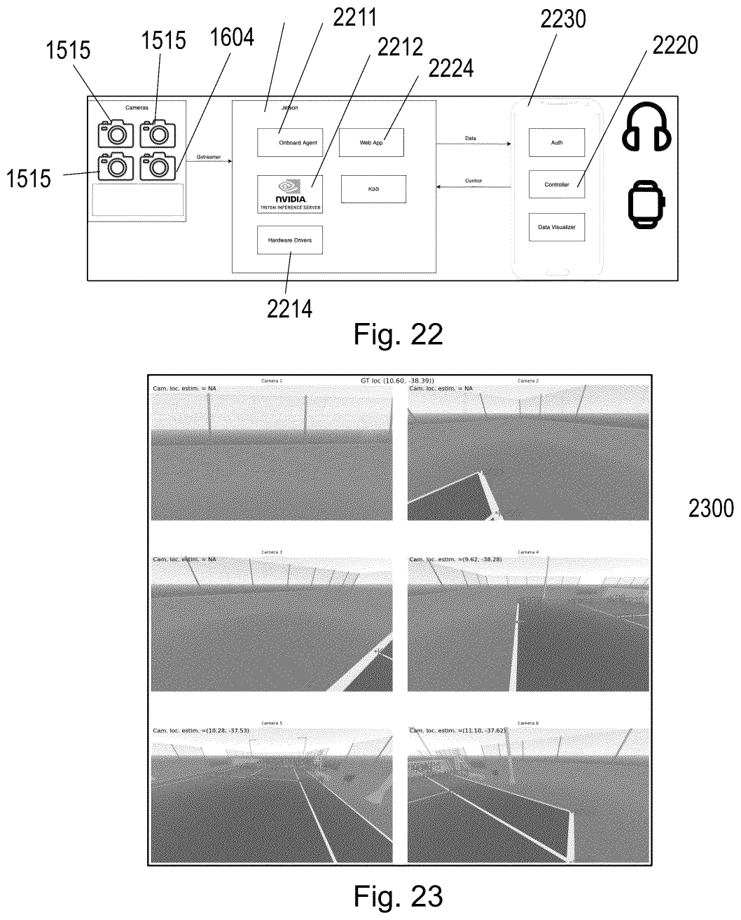

FIG. 22 a block diagram shows four IP cameras 1515, 1515, 1515, and 1604 streaming via GStreamer pipelines over Ethernet to an onboard Jetson AGX Orin or Jetson Orin Nano Super processor 2210. The Jetson hosts an onboard agent 2211, Nvidia Triton inference server 2212, and a lightweight container orchestration layer 2214 to manage models for localization, ball tracking, and shot analysis. Inference outputs include player pose, ball trajectories, and court keypoints; these feed a targeting engine and navigation controller. A web application service 2224 exposes user interfaces to a mobile device 2230 controller 2220 via WebRTC for video and command channels. Logged data is written to local or cloud storage for longitudinal analytics.

FIG. 23 shows a screen shot of user interface for AI-enabled navigation 2300. A court map overlay shows the device location icon, an auto-generated path, and geofenced safety boundaries derived from keypoint-based localization and RANSAC filtering. A status panel reports wheel state, battery state of charge, and proximity sensing. Manual controls allow forward, lateral, and rotational jogs using a virtual joystick or paired game controller. Detected obstacles are rendered along the path with avoidance maneuvers highlighted before execution.

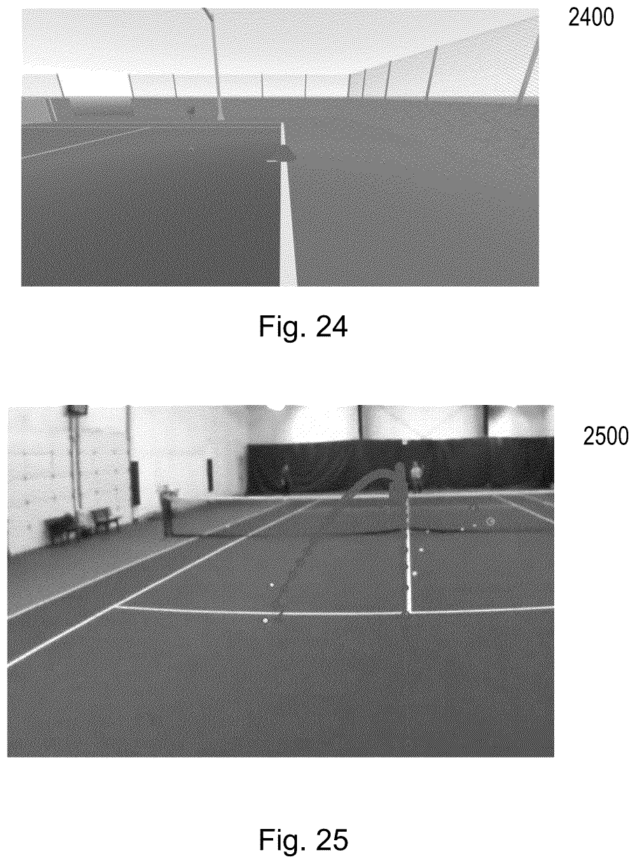

FIG. 24 shows a screenshot of a targeting interface 2400 with a court grid overlay and selectable target markers. Controls for ball speed, spin, and launch elevation define a motor configuration which a neural network predicts as a flight distance. Numerical optimization constrains the configuration within valid bounds while ensuring the first bounce occurs at the target. A predicted bounce indicator and accuracy heatmap update in real-time as parameters are adjusted. Profiles allow saving and recalling target sets for drills.

FIG. 25 shows a screenshot of an interface for ball tracking 2500 with trajectory overlays computed from multi-camera detections. A detected bounce marker is compared to the programmed target to compute placement error. An in-out indicator uses the court model to classify bounces relative to lines. A multi-track panel displays concurrent ball tracks with unique IDs and confidence bars. Historical traces are rendered with fading to visualize shot patterns over a rally.

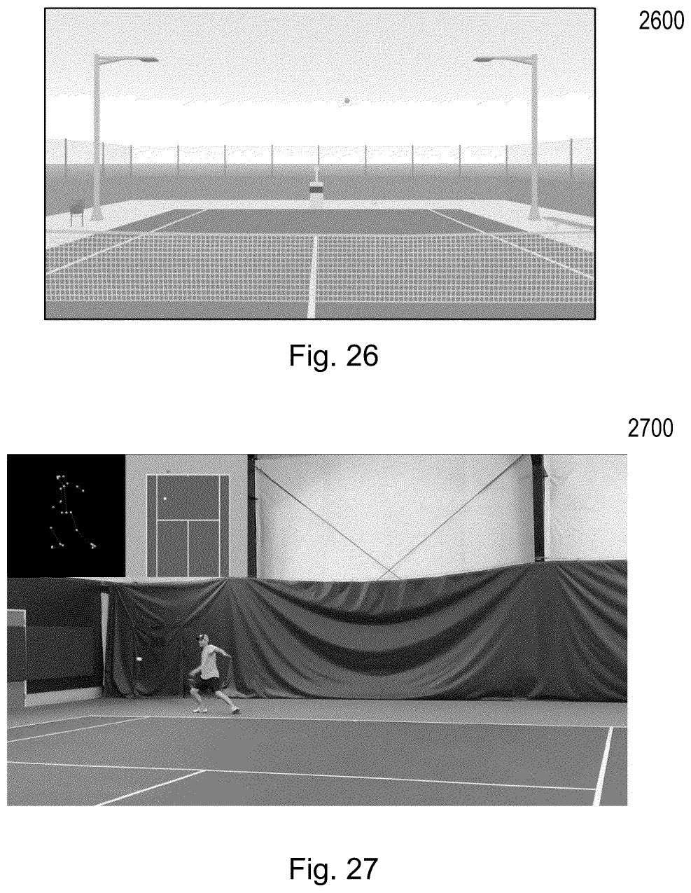

FIG. 26 shows a screenshot of an interface for shot and form analysis 2600. A synchronized video pane plays multi-angle clips while a generated text pane presents descriptive language outputs from a video-to-text network, for example identifying grip, contact timing, and spin. Metadata tags describing shot type, subtype, and quality are stored to a session record, enabling trend analysis over time. Suggested coaching cues are rendered as on-screen prompts or played via speakers for real-time guidance.

FIG. 27 depicts a screenshot of a virtual training simulation interface 2700 that mirrors the physical device. A 3D model of the machine operates on a virtual court with physics-based ball flight. Simulated camera feeds are streamed over standard protocols to the same perception stack for pre-deployment testing. An export function generates synthetic datasets with ground-truth labels to accelerate model training and validation.

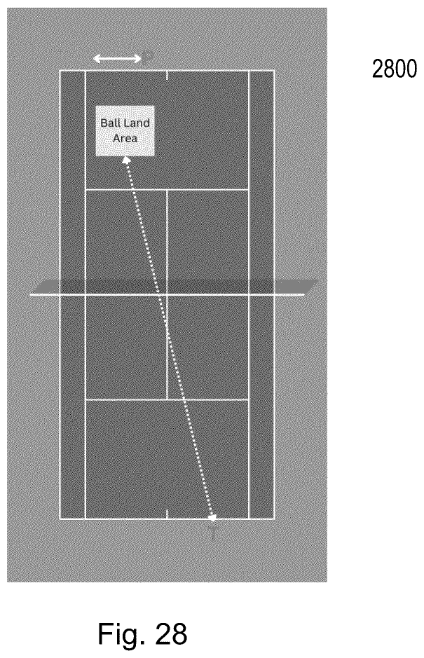

FIG. 28 shows a screenshot of an interface for AI-generated drill configuration 2800. A drill library lists recommended routines generated from recent performance metrics. Parameter editors define set count, reps, and rest intervals, as well as target zones and motor constraints. Voice cue definitions provide scripted instructions delivered during execution. A save and share control allows storing drills to the user profile and sharing with coaches or teams.

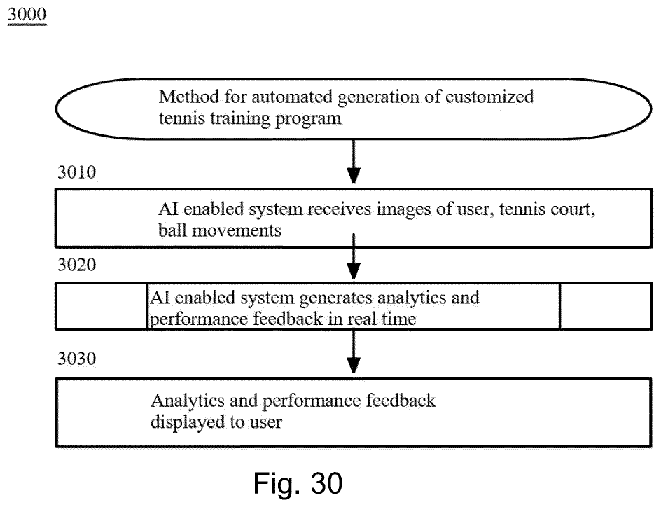

FIG. 30 is a flow diagram 3000 that illustrates automated generation of a customized training program. Session data ingestion 3010 collects player metrics, ball-placement statistics, and form descriptors derived from the camera system and sensors. Feature extraction and normalization 3020 compute per-skill performance vectors and fatigue indicators. Drill synthesis 3030 uses a rules-and-model hybrid to select targets, speeds, spins, and cadences that satisfy training objectives and safety constraints.

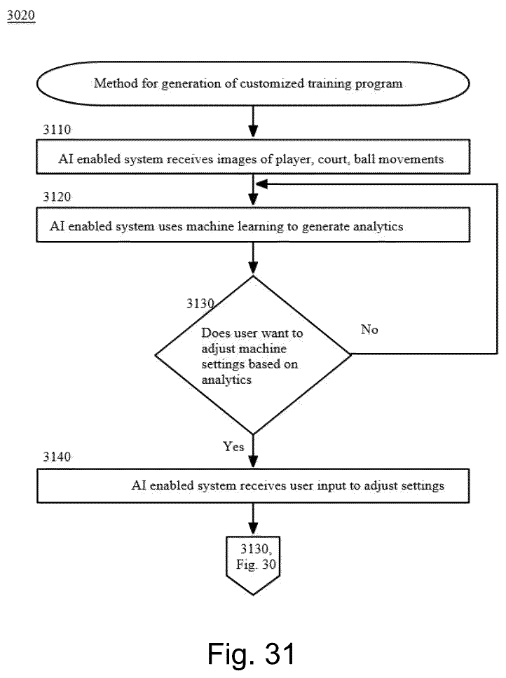

FIG. 31 shows a flow diagram 3100 that details adaptive training. Real-time metrics acquisition 3110 monitors placement accuracy, error types, and biomechanical cues. Evaluation and scoring 3120 compare actuals to goal envelopes. Plan update 3130 adjusts targets and motor configurations dynamically between balls or sets. A decision node 3140 tests whether performance thresholds are satisfied; if yes, progression 3150 advances difficulty or complexity.

As described above, the navigation subsystem leverages a neural network that detects tennis court line intersection keypoints and uses RANSAC for self-consistent localization. The omnidirectional wheel system allows holonomic motion, rotational alignment, and precise docking; movement is inhibited when people are detected within a safety radius. The targeting subsystem couples a neural network flight-distance predictor with numerical optimization to bound speed, spin, and launch elevation while guaranteeing first-bounce placement at a specified court coordinate. The ball-tracking subsystem fuses multi-camera detections using triangulation to estimate 3D position and calls balls in or out relative to the court model. The shot and form analysis subsystem uses a video-to-language model to generate rich descriptions which are distilled to metadata for longitudinal analytics.

### EXAMPLE SYSTEM ARCHITECTURES

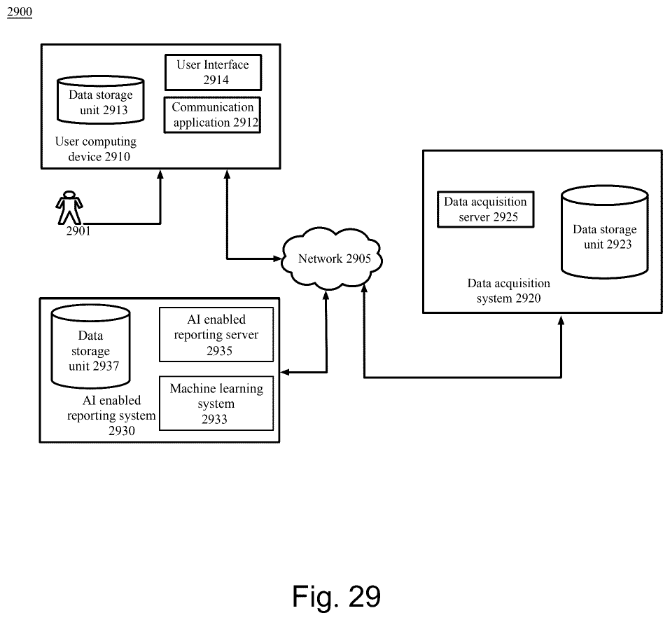

FIG. 29 is a block diagram depicting an AI enabled system 2900 to acquire images of a user/player, tennis, court, and ball movements from a database and generate a customized training program for the user. In one example embodiment, a user 101 associated with a user computing device 2910 must install an application, and or make a feature selection to obtain the benefits of the techniques described herein.

As depicted in FIG. 29, the system 2900 includes network computing devices/systems 2910, 2920, and 2930 that are configured to communicate with one another via one or more networks 105 or via any suitable communication technology.

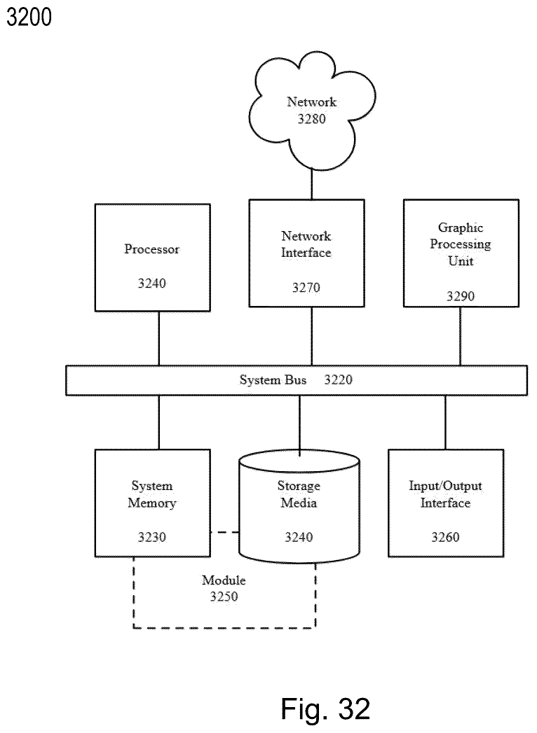

Each network 2905 includes a wired or wireless telecommunication means by which network devices/systems (including devices 2910, 2920, and 2930) can exchange data. For example, each network 2905 can include any of those described herein such as the network 3280 described in FIG. 32 or any combination thereof or any other appropriate architecture or system that facilitates the communication of signals and data. Throughout the discussion of example embodiments, it should be understood that the terms “data” and “information” are used interchangeably herein to refer to text, images, audio, video, or any other form of information that can exist in a computer-based environment. The communication technology utilized by the devices/systems 2910, 2920, and 2930 may be similar networks to network 2905 or an alternative communication technology.

Each network computing device/system 2910, 2920, and 2930 includes a computing device having a communication module capable of transmitting and receiving data over the network 105 or a similar network. For example, each network device/system 2910, 2920, and 2930 can include any computing machine 2000 described herein and found in FIG. 32 or any other wired or wireless, processor-driven device. In the example embodiment depicted in FIG. 29, the network devices/systems 2910, 2920, and 2930 are operated by user 2901, data acquisition system operators, and AI enabled reporting system operators, respectively.

The user computing device 2910 includes a user interface 2914. The user interface 2914 may be used to display a graphical user interface and other information to the user 2901 to allow the user 2901 to interact with the data acquisition system 2920, the AI enabled reporting system 2930, and others. The user interface 2914 receives user input for data acquisition and/or machine learning and displays results to user 3001. In another example embodiment, the user interface 2914 may be provided with a graphical user interface by the data acquisition system 2920 and or the AI enabled reporting system 2930. The user interface 2914 may be accessed by the processor of the user computing device 2910. The user interface may display 2914 may display a webpage associate with the data acquisition system 2920 and/or the AI enabled reporting system 2930. The user interface 2914 may be used to provide input, configuration data, and other display direction by the webpage of the data acquisition system 3120 and/or the AI enabled reporting system 2930. In another example embodiment, the user interface 2914 may be managed by the data acquisition system 2920, the AI enabled reporting system 2930, or others. In another example embodiment, the user interface 2914 may be managed by the user computing device 2910 and be prepared and displayed to the user 2901 based on the operations of the user computing device 2910.

The user 2901 can use the communication application 2912 on the user computing device 2910, which may be, for example, a web browser application or a stand-alone application, to view, download, upload, or otherwise access documents or web pages through the user interface 2914 via the network 2905. The user computing device 2910 can interact with the web servers or other computing devices connected to the network, including the data acquisition server 2925 of the data acquisition system 2920 and the AI enabled reporting server 2935 of the AI enabled reporting system 2930. In another example embodiment, the user computing device 2910 communicates with devices in the data acquisition system 2920 and/or the AI enabled reporting system 2930 via any other suitable technology, including the example computing system described below.

The user computing device 2910 also includes a data storage unit 2913 accessible by the user interface 2914, the communication application 2912, or other applications. The example data storage unit 2913 can include one or more tangible computer-readable storage devices. The data storage unit 2913 can be stored on the user computing device 2910 or can be logically coupled to the user computing device 2910. For example, the data storage unit 2913 can include on-board flash memory and/or one or more removable memory accounts or removable flash memory. In another example embodiments, the data storage unit 2913 may reside in a cloud-based computing system.

An example data acquisition system 2920 comprises a data storage unit 2923 and an acquisition server 2925. The data storage unit 2923 can include any local or remote data storage structure accessible to the data acquisition system 2920 suitable for storing information. The data storage unit 2923 can include one or more tangible computer-readable storage devices, or the data storage unit 2923 may be a separate system, such as a different physical or virtual machine or a cloud-based storage service.

In one aspect, the data acquisition server 2925 communicates with the user computing device 2910 and/or the AI enabled reporting system 2930 to transmit requested data. The data may include images captured by a camera system including, but not limited to, images and/or video of users/players, tennis court(s), and ball movements.

An example AI enabled reporting system 2930 comprises a machine learning system 2933, an AI enabled reporting server 2935, and a data storage unit 2937. The AI enabled reporting system 2930 is an AI-powered system. In an example, the AI enabled reporting system 2930 is a SaaS service model, or any other suitable service model. The AI-powered system includes subsets such as machine learning, deep learning, robotics, neural networks, natural language processing, genetic algorithms, and any combination thereof. The AI enabled reporting server 2935 communicates with the user computing device 2910 and/or the data acquisition system 2920 to request and receive data. The data may comprise the data types previously described in reference to the data acquisition server 2925.

The machine learning system 2933 receives an input of data from the AI enabled reporting server 2935. The machine learning system 2933 can comprise one or more functions to implement any of the mentioned training methods to learn and provide contextually relevant indexing of data for SEC compliant filing forms from company uploaded financial documents. In a preferred embodiment, the machine learning program may comprise a large language model (LLM). Any suitable architecture may be applied to learn and provide contextually relevant indexing of data to automatically generate and authenticate SEC compliant filing forms.

The data storage unit 2937 can include any local or remote data storage structure accessible to the AI enabled reporting system 2930 suitable for storing information. The data storage unit 2937 can include one or more tangible computer-readable storage devices, or the data storage unit 2937 may be a separate system, such as a different physical or virtual machine or a cloud-based storage service.

In an alternate embodiment, the functions of either or both of the data acquisition system 2920 and the AI enabled reporting system 2930 may be performed by the user computing device 2910.

It will be appreciated that the network connections shown are examples, and other means of establishing a communications link between the computers and devices can be used. Moreover, those having ordinary skill in the art having the benefit of the present disclosure will appreciate that the user computing device 2910, data acquisition system 2920, and the AI enabled reporting system 2930 illustrated in FIG. 29 can have any of several other suitable computer system configurations. For example, a user computing device 2910 embodied as a mobile phone or handheld computer may not include all the components described above.

In example embodiments, the network computing devices and any other computing machines associated with the technology presented herein may be any type of computing machine such as, but not limited to, those discussed in more detail with respect to FIG. 32. Furthermore, any modules associated with any of these computing machines, such as modules described herein or any other modules (scripts, web content, software, firmware, or hardware) associated with the technology presented herein may by any of the modules discussed in more detail with respect to FIG. 29. The computing machines discussed herein may communicate with one another as well as other computer machines or communication systems over one or more networks, such as network 2905. The network 2905 may include any type of data or communications network, including any of the network technology discussed with respect to FIG. 29.

### EXAMPLE PROCESSES

The example methods illustrated in FIGS. 30-31 are described hereinafter with respect to the components of the example architecture 2900. The example methods also can be performed with other systems and in other architectures including similar elements.

The ladder diagrams, scenarios, flowcharts and block diagrams in the figures and discussed herein illustrate architecture, functionality, and operation of example embodiments and various aspects of systems, methods, and computer program products of the present invention. Each block in the flowchart or block diagrams can represent the processing of information and/or transmission of information corresponding to circuitry that can be configured to execute the logical functions of the present techniques. Each block in the flowchart or block diagrams can represent a module, segment, or portion of one or more executable instructions for implementing the specified operation or step. In example embodiments, the functions/acts in a block can occur out of the order shown in the figures and nothing requires that the operations be performed in the order illustrated. For example, two blocks shown in succession can be executed concurrently or essentially concurrently. In another example, blocks can be executed in the reverse order. Furthermore, variations, modifications, substitutions, additions, or reduction in blocks and/or functions may be used with any of the ladder diagrams, scenarios, flow charts and block diagrams discussed herein, all of which are explicitly contemplated herein.

The ladder diagrams, scenarios, flow charts and block diagrams may be combined with one another, in part or in whole. Coordination will depend upon the required functionality. Each block of the block diagrams and/or flowchart illustration as well as combinations of blocks in the block diagrams and/or flowchart illustrations can be implemented by special purpose hardware-based systems that perform the aforementioned functions/acts or carry out combinations of special purpose hardware and computer instructions. Moreover, a block may represent one or more information transmissions and may correspond to information transmissions among software and/or hardware modules in the same physical device and/or hardware modules in different physical devices.

The present techniques can be implemented as a system, a method, a computer program product, digital electronic circuitry, and/or in computer hardware, firmware, software, or in combinations of them. The system may comprise distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors such as a processor of the AI enable reporting system.

The computer program product can include a program tangibly embodied in an information carrier (e.g., computer readable storage medium or media) having computer readable program instructions thereon for execution by, or to control the operation of, data processing apparatus (e.g., a processor) to carry out aspects of one or more embodiments of the present invention. It will be understood that each block of the flowchart illustrations and/or block diagrams, and combinations of blocks in the flowchart illustrations and/or block diagrams, can be implemented by computer readable program instructions.

The computer readable program instructions can be performed on general purpose computing device, special purpose computing device, or other programmable data processing apparatus to produce a machine, such that the instructions, which execute via, at least partially, by one or more processors that are temporarily configured (e.g., by software) or permanently configured to perform the functions/acts specified in the flowchart and/or block diagram block or blocks. The processors, either: temporarily or permanently; or partially configured, may comprise processor-implemented modules. The present techniques referred to herein may, in example embodiments, comprise processor-implemented modules. Functions/acts of the processor-implemented modules may be distributed among the one or more processors. Moreover, the functions/acts of the processor-implements modules may be deployed across a number of machines, where the machines may be located in a single geographical location or distributed across a number of geographical locations.

The computer readable program instructions can also be stored in a computer readable storage medium that can direct one or more computer devices, programmable data processing apparatuses, and/or other devices to carry out the function/acts of the processor-implemented modules. The computer readable storage medium containing all or partial processor-implemented modules stored therein, comprises an article of manufacture including instructions which implement aspects, operations, or steps to be performed of the function/act specified in the flowchart and/or block diagram block or blocks.

Computer readable program instructions described herein can be downloaded to a computer readable storage medium within a respective computing/processing devices from a computer readable storage medium. Optionally, the computer readable program instructions can be downloaded to an external computer device or external storage device via a network. A network adapter card or network interface in each computing/processing device can receive computer readable program instructions from the network and forward the computer readable program instructions for permanent or temporary storage in a computer readable storage medium within the respective computing/processing device.

Computer readable program instructions described herein can be assembler instructions, instruction-set-architecture (ISA) instructions, machine instructions, machine dependent instructions, microcode, firmware instructions, state-setting data, or either source code or object code. The computer readable program instructions can be written in any programming language such as compiled or interpreted languages. In addition, the programming language can be object-oriented programming language (e.g., “C++”) or conventional procedural programming languages (e.g., “C”) or any combination thereof may be used to as computer readable program instructions. The computer readable program instructions can be distributed in any form, for example as a stand-alone program, module, subroutine, or other unit suitable for use in a computing environment. The computer readable program instructions can execute entirely on one computer or on multiple computers at one site or across multiple sites connected by a communication network, for example on user's computer, partly on the user's computer, as a stand-alone software package, partly on the user's computer and partly on a remote computer or entirely on a remote computer or server. If the computer readable program instructions are executed entirely remote, then the remote computer can be connected to the user's computer through any type of network, or the connection can be made to an external computer. In examples embodiments, electronic circuitry including, but not limited to, programmable logic circuitry, field-programmable gate arrays (FPGA), or programmable logic arrays (PLA) can execute the computer readable program instructions. Electronic circuitry can utilize state information of the computer readable program instructions to personalize the electronic circuitry, to execute functions/acts of one or more embodiments of the present invention.

Example embodiments described herein include logic or a number of components, modules, or mechanisms. Modules may comprise either software modules or hardware-implemented modules. A software module may be code embodied on a non-transitory machine-readable medium or in a transmission signal. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In example embodiments, a hardware-implemented module may be implemented mechanically or electronically. In example embodiments, hardware-implemented modules may comprise permanently configured dedicated circuitry or logic to execute certain functions/acts such as a special-purpose processor or logic circuitry (e.g., a field programmable gate array (FPGA) or an application-specific integrated circuit (ASIC)). In example embodiments, hardware-implemented modules may comprise temporary programmable logic or circuitry to perform certain functions/acts. For example, a general-purpose processor or other programmable processor.

The term “hardware-implemented module” encompasses a tangible entity. A tangible entity may be physically constructed, permanently configured, or temporarily or transitorily configured to operate in a certain manner and/or to perform certain functions/acts described herein. Hardware-implemented modules that are temporarily configured need not be configured or instantiated at any one time. For example, if the hardware-implemented modules comprise a general-purpose processor configured using software, then the general-purpose processor may be configured as different hardware-implemented modules at different times.

Hardware-implemented modules can provide, receive, and/or exchange information from/with other hardware-implemented modules. The hardware-implemented modules herein may be communicatively coupled. Multiple hardware-implemented modules operating concurrently, may communicate through signal transmission, for instance appropriate circuits and buses that connect the hardware-implemented modules. Multiple hardware-implemented modules configured or instantiated at different times may communicate through temporarily or permanently archived information, for instance the storage and retrieval of information in memory structures to which the multiple hardware-implemented modules have access. For example, one hardware-implemented module may perform an operation, and store the output of that operation in a memory device to which it is communicatively coupled. Consequently, another hardware-implemented module may, at some time later, access the memory device to retrieve and process the stored information. Hardware-implemented modules may also initiate communications with input or output devices and can operate on information from the input or output devices.

In example embodiments, the present techniques can be at least partially implemented in a cloud or virtual machine environment.

One or more processors may also operate to support performance of the relevant operations in a “cloud computing” environment or as a “software as a service” (SaaS). For example, at least some of the operations may be performed by a group of computers, these operations being accessible via a network and via one or more appropriate interfaces (e.g., application program interfaces (APIs)).

### SERVICE MODELS

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

A cloud computing environment is service oriented with a focus on statelessness, low coupling, modularity, and semantic interoperability. At the heart of cloud computing is an infrastructure comprising a network of interconnected nodes.

### CLOUD COMPUTING ENVIRONMENT

A cloud computing environment includes one or more cloud computing nodes with which local computing devices used by cloud consumers, such as, for example, personal digital assistant (PDA) or cellular telephone, desktop computer, laptop computer, and/or automobile computer system may communicate. Nodes may communicate with one another. They may be grouped physically or virtually, in one or more networks, such as Private, Community, Public, or Hybrid clouds, or a combination thereof. This allows a cloud computing environment to offer infrastructure, platforms and/or software as services for which a cloud consumer does not need to maintain resources on a local computing device. It is understood that the types of computing devices described above are intended to be illustrative only and that computing nodes and the cloud computing environment can communicate with any type of computerized device over any type of network and/or network addressable connection (e.g., using a web browser).

### DEPLOYMENT MODELS

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

### MACHINE LEARNING

Machine learning is a field of study within artificial intelligence that allows computers to learn functional relationships between inputs and outputs without being explicitly programmed. Machine learning involves a module comprising algorithms that may learn from existing data by analyzing, categorizing, or identifying the data. Such machine-learning algorithms operate by first constructing a model from training data to make predictions or decisions expressed as outputs. In example embodiments, the training data includes data for one or more identified features and one or more outcomes, for example the training data can include historical financial data and previously file SEC documents. Although example embodiments are presented with respect to a few machine-learning algorithms, the principles presented herein may be applied to other machine-learning algorithms.

Data supplied to a machine learning algorithm can be considered a feature, which can be described as an individual measurable property of a phenomenon being observed. The concept of feature is related to that of an independent variable used in statistical techniques such as those used in linear regression. The performance of a machine learning algorithm in pattern recognition, classification and regression is highly dependent on choosing informative, discriminating, and independent features. Features may comprise numerical data, categorical data, time-series data, strings, graphs, or images.

In general, there are two categories of machine learning problems: classification problems and regression problems. Classification problems, also referred to as categorization problems, aim at classifying items into discrete category values. Training data teaches the classifying algorithm how to classify. In example embodiments, features to be categorized may include subsets of financial data, which can be provided to the classifying machine learning algorithm and then placed into categories of, for example, contextual information, document format and structure, numerical values, calculations, and financial ratios. Regression algorithms aim at quantifying and correlating one or more features. Training data teaches the regression algorithm how to correlate the one or more features into a quantifiable value.

### EMBEDDING

In one example, the machine learning module may use embedding to provide a lower dimensional representation, such as a vector, of features to organize them based off respective similarities. In some situations, these vectors can become massive. In the case of massive vectors, particular values may become very sparse among a large number of values (e.g., a single instance of a value among 50,000 values). Because such vectors are difficult to work with, reducing the size of the vectors, in some instances, is necessary. A machine learning module can learn the embeddings along with the model parameters. In example embodiments, embedded semantic meanings are utilized. Embedded semantic meanings are values of respective similarity. For example, the distance between two vectors, in vector space, may imply two values located elsewhere with the same distance are categorically similar. Embedded semantic meanings can be used with similarity analysis to rapidly return similar values. In example embodiments, the methods herein are developed to identify meaningful portions of the vector and extract semantic meanings between that space.

### TRAINING METHODS

In example embodiments, the machine learning module can be trained using techniques such as unsupervised, supervised, semi-supervised, reinforcement learning, transfer learning, incremental learning, curriculum learning techniques, and/or learning to learn. Training typically occurs after selection and development of a machine learning module and before the machine learning module is operably in use. In one aspect, the training data used to teach the machine learning module can comprise input data such as financial data and the respective target output data such as fields within SEC filing forms.

In an example embodiment, unsupervised learning is implemented. Unsupervised learning can involve providing all or a portion of unlabeled training data to a machine learning module. The machine learning module can then determine one or more outputs implicitly based on the provided unlabeled training data. In an example embodiment, supervised learning is implemented. Supervised learning can involve providing all or a portion of labeled training data to a machine learning module, with the machine learning module determining one or more outputs based on the provided labeled training data, and the outputs are either accepted or corrected depending on the agreement to the actual outcome of the training data. In some examples, supervised learning of machine learning system(s) can be governed by a set of rules and/or a set of labels for the training input, and the set of rules and/or set of labels may be used to correct inferences of a machine learning module.

In one example embodiment, semi-supervised learning is implemented. Semi-supervised learning can involve providing all or a portion of training data that is partially labeled to a machine learning module. During semi-supervised learning, supervised learning is used for a portion of labeled training data, and unsupervised learning is used for a portion of unlabeled training data. In one example embodiment, reinforcement learning is implemented. Reinforcement learning can involve first providing all or a portion of the training data to a machine learning module and as the machine learning module produces an output, the machine learning module receives a “reward” signal in response to a correct output. Typically, the reward signal is a numerical value, and the machine learning module is developed to maximize the numerical value of the reward signal. In addition, reinforcement learning can adopt a value function that provides a numerical value representing an expected total of the numerical values provided by the reward signal over time.

In one example embodiment, transfer learning is implemented. Transfer learning techniques can involve providing all or a portion of a first training data to a machine learning module, then, after training on the first training data, providing all or a portion of a second training data. In example embodiments, a first machine learning module can be pre-trained on data from one or more computing devices. The first trained machine learning module is then provided to a computing device, where the computing device is intended to execute the first trained machine learning model to produce an output. Then, during the second training phase, the first trained machine learning model can be additionally trained using additional training data, where the training data can be derived from kernel and non-kernel data of one or more computing devices. This second training of the machine learning module and/or the first trained machine learning model using the training data can be performed using either supervised, unsupervised, or semi-supervised learning. In addition, it is understood transfer learning techniques can involve one, two, three, or more training attempts. Once the machine learning module has been trained on at least the training data, the training phase can be completed. The resulting trained machine learning model can be utilized as at least one of trained machine learning module.

In one example embodiment, incremental learning is implemented. Incremental learning techniques can involve providing a trained machine learning module with input data that is used to continuously extend the knowledge of the trained machine learning module. Another machine learning training technique is curriculum learning, which can involve training the machine learning module with training data arranged in a particular order, such as providing relatively easy training examples first, then proceeding with progressively more difficult training examples. As the name suggests, difficulty of training data is analogous to a curriculum or course of study at a school.

In one example embodiment, learning to learn is implemented. Learning to learn, or meta-learning, comprises, in general, two levels of learning: quick learning of a single task and slower learning across many tasks. For example, a machine learning module is first trained and comprises of a first set of parameters or weights. During or after operation of the first trained machine learning module, the parameters or weights are adjusted by the machine learning module. This process occurs iteratively on the success of the machine learning module. In another example, an optimizer, or another machine learning module, is used wherein the output of a first trained machine learning module is fed to an optimizer that constantly learns and returns the final results. Other techniques for training the machine learning module and/or trained machine learning module are possible as well.

In some examples, after the training phase has been completed but before producing predictions expressed as outputs, a trained machine learning module can be provided to a computing device where a trained machine learning module is not already resident, in other words, after training phase has been completed, the trained machine learning module can be downloaded to a computing device. For example, a first computing device storing a trained machine learning module can provide the trained machine learning module to a second computing device. Providing a trained machine learning module to the second computing device may comprise one or more of communicating a copy of trained machine learning module to the second computing device, making a copy of trained machine learning module for the second computing device, providing access to trained machine learning module to the second computing device, and/or otherwise providing the trained machine learning system to the second computing device. In example embodiments, a trained machine learning module can be used by the second computing device immediately after being provided by the first computing device. In some examples, after a trained machine learning module is provided to the second computing device, the trained machine learning module can be installed and/or otherwise prepared for use before the trained machine learning module can be used by the second computing device.

After a machine learning model has been trained it can be used to output, estimate, infer, predict, generate, or determine, for simplicity these terms will collectively be referred to as results. A trained machine learning module can receive input data and operably generate results. As such, the input data can be used as an input to the trained machine learning module for providing corresponding results to kernel components and non-kernel components. For example, a trained machine learning module can generate results in response to requests. In example embodiments, a trained machine learning module can be executed by a portion of other software. For example, a trained machine learning module can be executed by a result daemon to be readily available to provide results upon request.

In example embodiments, a machine learning module and/or trained machine learning module can be executed and/or accelerated using one or more computer processors and/or on-device co-processors. Such on-device co-processors can speed up training of a machine learning module and/or generation of results. In some examples, trained machine learning module can be trained, reside, and execute to provide results on a particular computing device, and/or otherwise can make results for the particular computing device.

Input data can include data from a computing device executing a trained machine learning module and/or input data from one or more computing devices. In example embodiments, a trained machine learning module can use results as input feedback. A trained machine learning module can also rely on past results as inputs for generating new results. In example embodiments, input data can comprise previously filed SEC forms and, when provided to a trained machine learning module, results in output data such as SEC compliant filing forms based on company provided financial documents.

### ALGORITHMS

Different machine-learning algorithms have been contemplated to carry out the embodiments discussed herein. For example, linear regression (LiR), logistic regression (LoR), Bayesian networks (for example, naive-bayes), random forest (RF) (including decision trees), neural networks (NN) (also known as artificial neural networks), matrix factorization, a hidden Markov model (HMM), support vector machines (SVM), K-means clustering (KMC), K-nearest neighbor (KNN), a suitable statistical machine learning algorithm, and/or a heuristic machine learning system for classifying or evaluating financial data.

### LINEAR REGRESSION (LiR)

In one example embodiment, linear regression machine learning is implemented. LiR is typically used in machine learning to predict a result through the mathematical relationship between an independent and dependent variable. A simple linear regression model would have one independent variable (x) and one dependent variable (y). A representation of an example mathematical relationship of a simple linear regression model would be y=mx+b. In this example, the machine learning algorithm tries variations of the tuning variables m and b to optimize a line that includes all the given training data.

The tuning variables can be optimized, for example, with a cost function. A cost function takes advantage of the minimization problem to identify the optimal tuning variables. The minimization problem preposes the optimal tuning variable will minimize the error between the predicted outcome and the actual outcome. An example cost function may comprise summing all the square differences between the predicted and actual output values and dividing them by the total number of input values and results in the average square error.

To select new tuning variables to reduce the cost function, the machine learning module may use, for example, gradient descent methods. An example gradient descent method comprises evaluating the partial derivative of the cost function with respect to the tuning variables. The sign and magnitude of the partial derivatives indicate whether the choice of a new tuning variable value will reduce the cost function, thereby optimizing the linear regression algorithm. A new tuning variable value is selected depending on a set threshold. Depending on the machine learning module, a steep or gradual negative slope is selected. Both the cost function and gradient descent can be used with other algorithms and modules mentioned throughout. For the sake of brevity, both the cost function and gradient descent are well known in the art and are applicable to other machine learning algorithms and may not be mentioned with the same detail.

LiR models may have many levels of complexity comprising one or more independent variables. Furthermore, in an LiR function with more than one independent variable, each independent variable may have the same one or more tuning variables or each, separately, may have their own one or more tuning variables. The number of independent variables and tuning variables will be understood to one skilled in the art for the problem being solved.

### LOGISTIC REGRESSION (LoR)

In one example embodiment, logistic regression machine learning is implemented. Logistic Regression, often considered a LoR type model, is typically used in machine learning to classify information, such as financial data into categories required in SEC filing forms. LoR takes advantage of probability to predict an outcome from input data. However, what makes LoR different from a LiR is that LoR uses a more complex logistic function, for example a sigmoid function. In addition, the cost function can be a sigmoid function limited to a result between 0 and 1. For example, the sigmoid function can be of the form f(x)=1/(1+e^{-x}), where x represents some linear representation of input features and tuning variables. Similar to LiR, the tuning variable(s) of the cost function are optimized (typically by taking the log of some variation of the cost function) such that the result of the cost function, given variable representations of the input features, is a number between 0 and 1, preferably falling on either side of 0.5. As described in LiR, gradient descent may also be used in LoR cost function optimization and is an example of the process.

### BAYESIAN NETWORK

In one example embodiment, a Bayesian Network is implemented. BNs are used in machine learning to make predictions through Bayesian inference from probabilistic graphical models. In BNs, input features are mapped onto a directed acyclic graph forming the nodes of the graph. The edges connecting the nodes contain the conditional dependencies between nodes to form a predicative model. For each connected node the probability of the input features resulting in the connected node is learned and forms the predictive mechanism. The nodes may comprise the same, similar or different probability functions to determine movement from one node to another. The nodes of a Bayesian network are conditionally independent of its non-descendants given its parents thus satisfying a local Markov property. This property affords reduced computations in larger networks by simplifying the joint distribution.

There are multiple methods to evaluate the inference, or predictability, in a BN but only two are mentioned for demonstrative purposes. The first method involves computing the joint probability of a particular assignment of values for each variable. The joint probability can be considered the product of each conditional probability and, in some instances, comprises the logarithm of that product. The second method is Markov chain Monte Carlo (MCMC), which can be implemented when the sample size is large. MCMC is a well-known class of sample distribution algorithms and will not be discussed in detail herein.

The assumption of conditional independence of variables forms the basis for Naïve Bayes classifiers. This assumption implies there is no correlation between different input features. As a result, the number of computed probabilities is significantly reduced as well as the computation of the probability normalization. While independence between features is rarely true, this assumption exchanges reduced computations for less accurate predictions, however the predictions are reasonably accurate.

### RANDOM FOREST

In one example embodiment, random forest is implemented. RF consists of an ensemble of decision trees producing individual class predictions. The prevailing prediction from the ensemble of decision trees becomes the RF prediction. Decision trees are branching flowchart-like graphs comprising of the root, nodes, edges/branches, and leaves. The root is the first decision node from which feature information is assessed and from it extends the first set of edges/branches. The edges/branches contain the information of the outcome of a node and pass the information to the next node. The leaf nodes are the terminal nodes that output the prediction. Decision trees can be used for both classification as well as regression and is typically trained using supervised learning methods. Training of a decision tree is sensitive to the training data set. An individual decision tree may become over or under-fit to the training data and result in a poor predictive model. Random forest compensates by using multiple decision trees trained on different data sets.

### GRADIENT BOOSTING

In an example embodiment, gradient boosting is implemented. Gradient boosting is a method of strengthening the evaluation capability of a decision tree node. In general, a tree is fit on a modified version of an original data set. For example, a decision tree is first trained with equal weights across its nodes. The decision tree is allowed to evaluate data to identify nodes that are less accurate. Another tree is added to the model and the weights of the corresponding underperforming nodes are then modified in the new tree to improve their accuracy. This process is performed iteratively until the accuracy of the model has reached a defined threshold or a defined limit of trees has been reached. Less accurate nodes are identified by the gradient of a loss function. Loss functions must be differentiable such as a linear or logarithmic functions. The modified node weights in the new tree are selected to minimize the gradient of the loss function.

### NEURAL NETWORKS

In one example embodiment, Neural Networks are implemented. NNs are a family of statistical learning models influenced by biological neural networks of the brain. NNs can be trained on a relatively large dataset (e.g., 50,000 or more) and used to estimate, approximate, or predict an output that depends on a large number of inputs/features. NNs can be envisioned as so-called “neuromorphic” systems of interconnected processor elements, or “neurons”, and exchange electronic signals, or “messages”. Similar to the so-called “plasticity” of synaptic neurotransmitter connections that carry messages between biological neurons, the connections in NNs that carry electronic “messages” between “neurons” are provided with numeric weights that correspond to the strength or weakness of a given connection. The weights can be tuned based on experience, making NNs adaptive to inputs and capable of learning. The input neuron weighs and transforms the input data and passes the result to other neurons, often referred to as “hidden” neurons. This is repeated until an output neuron is activated. The activated output neuron produces a result. A neural network may also be referred to as a large language model (LLM).

### CONVOLUTIONAL AUTOENCODER

In example embodiments, convolutional autoencoder (CAE) is implemented. A CAE is a type of neural network and comprises, in general, two main components. First, the convolutional operator that filters an input signal to extract features of the signal. Second, an autoencoder that learns a set of signals from an input and reconstructs the signal into an output. By combining these two components, the CAE learns the optimal filters that minimize reconstruction error resulting an improved output. CAEs are trained to only learn filters capable of feature extraction that can be used to reconstruct the input. Generally, convolutional autoencoders implement unsupervised learning. In example embodiments, the convolutional autoencoder is a variational convolutional autoencoder.

### DEEP LEARNING

In example embodiments, deep learning is implemented. Deep learning expands the neural network by including more layers of neurons. A deep learning module is characterized as having three “macro” layers: (1) an input layer which takes in the input features, and fetches embeddings for the input, (2) one or more intermediate (or hidden) layers which introduces nonlinear neural net transformations to the inputs, and (3) a response layer which transforms the final results of the intermediate layers to the prediction.

### RECURRENT NEURAL NETWORK (RNN)

In an example embodiment, a recurrent neural network is implemented. RNNs are class of NNs further attempting to replicate the biological neural networks of the brain. RNNs comprise of delay differential equations on sequential data or time series data to replicate the processes and interactions of the human brain. RNNs have “memory” wherein the RNN can take information from prior inputs to influence the current output. RNNs can process variable length sequences of inputs by using their “memory” or internal state information. Where NNs may assume inputs are independent from the outputs, the outputs of RNNs may be dependent on prior elements with the input sequence. See Sherstinsky, Alex. “Fundamentals of recurrent neural network (RNN) and long short-term memory (LSTM) network.” Physica D: Nonlinear Phenomena 404 (2020): 132306.

### LONG SHORT-TERM MEMORY (LSTM)

In an example embodiment, a Long Short-term Memory is implemented. LSTM are a class of RNNs designed to overcome vanishing and exploding gradients. In RNNs, long term dependencies become more difficult to capture because the parameters or weights either do not change with training or fluctuate rapidly. This occurs when the RNN gradient exponentially decreases to zero, resulting in no change to the weights or parameters, or exponentially increases to infinity, resulting in large changes in the weights or parameters. This exponential effect is dependent on the number of layers and multiplicative gradient. LSTM overcomes the vanishing/exploding gradients by implementing “cells” within the hidden layers of the NN. The “cells” comprise three gates: an input gate, an output gate, and a forget gate. The input gate reduces error by controlling relevant inputs to update the current cell state. The output gate reduces error by controlling relevant memory content in the present hidden state. The forget gate reduces error by controlling whether prior cell states are put in “memory” or forgotten. The gates use activation functions to determine whether the data can pass through the gates. While one skilled in the art would recognize the use of any relevant activation function, example activation functions are sigmoid, tanh, and RELU. See Zhu, Xiaodan, et al. “Long short-term memory over recursive structures.” International Conference on Machine Learning. PMLR, 2015.

### CONVOLUTIONAL NEURAL NETWORK (CNN)

In an example embodiment, a convolutional neural network is implemented. CNNs is a class of NNs further attempting to replicate the biological neural networks, but of the animal visual cortex. CNNS process data with a grid pattern to learn spatial hierarchies of features. A typical CNN comprises of three layers: convolution, pooling, and fully connected. The convolution and pooling layers extract features, such as those described herein. The convolutional layer comprises of multiple mathematical operations such as of linear operations, a specialized type being a convolution. The fully connected layer combines the extracted features into an output. The input data, such as financial data may be represented in a grid, i.e., an array of numbers. A grid of parameters, called a kernel, operates as an optimizable feature extractor and is applied to each position in the grid. Extracted features may become hierarchically more complex as one layer feeds its output into the next layer.

See Yamashita, R., et al Convolutional neural networks: an overview and application in radiology. Insights Imaging 9, 611-629 (2018).

### MATRIX FACTORIZATION

In example embodiments, Matrix Factorization is implemented. Matrix factorization machine learning exploits inherent relationships between two entities drawn out when multiplied together. Generally, the input features are mapped to a matrix F which is multiplied with a matrix R containing the relationship between the features and a predicted outcome. The resulting dot product provides the prediction. The matrix R is constructed by assigning random values throughout the matrix. In this example, two training matrices are assembled. The first matrix X contains training input features, and the second matrix Z contains the known output of the training input features. First the dot product of R and X are computed and the square mean error, as one example method, of the result is estimated. The values in R are modulated and the process is repeated in a gradient descent style approach until the error is appropriately minimized. The trained matrix R is then used in the machine learning model.

### HIDDEN MARKOV MODEL

In example embodiments, a hidden Markov model is implemented. A HMM takes advantage of the statistical Markov model to predict an outcome. A Markov model assumes a Markov process, wherein the probability of an outcome is solely dependent on the previous event. In the case of HMM, it is assumed an unknown or “hidden” state is dependent on some observable event. A HMM comprises a network of connected nodes. Traversing the network is dependent on three model parameters: start probability; state transition probabilities; and observation probability. The start probability is a variable that governs, from the input node, the most plausible consecutive state. From there each node i has a state transition probability to node j. Typically the state transition probabilities are stored in a matrix Mᵢⱼ wherein the sum of the rows, representing the probability of state i transitioning to state j, equals 1. The observation probability is a variable containing the probability of output o occurring. These too are typically stored in a matrix Nₒⱼ wherein the probability of output o is dependent on state j. To build the model parameters and train the HMM, the state and output probabilities are computed. This can be accomplished with, for example, an inductive algorithm. Next, the state sequences are ranked on probability, which can be accomplished, for example, with the Viterbi algorithm. Finally, the model parameters are modulated to maximize the probability of a certain sequence of observations. This is typically accomplished with an iterative process wherein the neighborhood of states is explored, the probabilities of the state sequences are measured, and model parameters updated to increase the probabilities of the state sequences.

### SUPPORT VECTOR MACHINE

In example embodiments, support vector machines are implemented. SVMs separate data into classes defined by n-dimensional hyperplanes (n-hyperplane) and are used in both regression and classification problems. Hyperplanes are decision boundaries developed during the training process of a SVM. The dimensionality of a hyperplane depends on the number of input features. For example, a SVM with two input features will have a linear (1-dimensional) hyperplane while a SVM with three input features will have a planer (2-dimensional) hyperplane. A hyperplane is optimized to have the largest margin or spatial distance from the nearest data point for each data type. In the case of simple linear regression and classification a linear equation is used to develop the hyperplane. However, when the features are more complex a kernel is used to describe the hyperplane. A kernel is a function that transforms the input features into higher dimensional space. Kernel functions can be linear, polynomial, a radial distribution function (or gaussian radial distribution function), or sigmoidal.

### K-MEANS CLUSTERING

In one example embodiment, K-means clustering is implemented. KMC assumes data points have implicit shared characteristics and “clusters” data within a centroid or “mean” of the clustered data points. During training, KMC adds a number of k centroids and optimizes its position around clusters. This process is iterative, where each centroid, initially positioned at random, is re-positioned towards the average point of a cluster. This process concludes when the centroids have reached an optimal position within a cluster. Training of a KMC module is typically unsupervised.

### K-NEAREST NEIGHBOR

In one example embodiment, K-nearest neighbor is implemented. On a general level, KNN shares similar characteristics to KMC. For example, KNN assumes data points near each other share similar characteristics and computes the distance between data points to identify those similar characteristics but instead of k centroids, KNN uses k number of neighbors. The k in KNN represents how many neighbors will assign a data point to a class, for classification, or object property value, for regression. Selection of an appropriate number of k is integral to the accuracy of KNN. For example, a large k may reduce random error associated with variance in the data but increase error by ignoring small but significant differences in the data. Therefore, a careful choice of k is selected to balance overfitting and underfitting. Concluding whether some data point belongs to some class or property value k, the distance between neighbors is computed. Common methods to compute this distance are Euclidean, Manhattan or Hamming to name a few. In some embodiments, neighbors are given weights depending on the neighbor distance to scale the similarity between neighbors to reduce the error of edge neighbors of one class “out-voting” near neighbors of another class. In one example embodiment, k is 1 and a Markov model approach is utilized.

To perform one or more of its functionalities, the machine learning module may communicate with one or more other systems. For example, an integration system may integrate the machine learning module with one or more email servers, web servers, one or more databases, or other servers, systems, or repositories. In addition, one or more functionalities may require communication between a user and the machine learning module.

Any one or more of the modules described herein may be implemented using hardware (e.g., one or more processors of a computer/machine) or a combination of hardware and software. For example, any module described herein may configure a hardware processor (e.g., among one or more hardware processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, to allow information to be passed between the applications so as to allow the applications to share and access common data.

### EXAMPLE COMPUTING DEVICE

FIG. 32 depicts a block diagram of a computing machine 2000 and a module 3250 in accordance with certain examples. The computing machine 3200 may comprise, but are not limited to, remote devices, work stations, servers, computers, general purpose computers, Internet/web appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, game consoles, set-top boxes, network PCs, mini-computers, and any machine capable of executing the instructions. The module 3250 may comprise one or more hardware or software elements configured to facilitate the computing machine 3200 in performing the various methods and processing functions presented herein. The computing machine 3200 may include various internal or attached components such as a processor 3210, system bus 3232, system memory 3230, storage media 3240, input/output interface 3260, and a network interface 3270 for communicating with a network 3280.

The computing machine 3200 may be implemented as a conventional computer system, an embedded controller, a laptop, a server, a mobile device, a smartphone, a set-top box, a kiosk, a router or other network node, a vehicular information system, one or more processors associated with a television, a customized machine, any other hardware platform, or any combination or multiplicity thereof. The computing machine 3200 may be a distributed system configured to function using multiple computing machines interconnected via a data network or bus system.

The one or more processor 3210 may be configured to execute code or instructions to perform the operations and functionality described herein, manage request flow and address mappings, and to perform calculations and generate commands. Such code or instructions could include, but is not limited to, firmware, resident software, microcode, and the like. The processor 3210 may be configured to monitor and control the operation of the components in the computing machine 3200. The processor 3210 may be a general purpose processor, a processor core, a multiprocessor, a reconfigurable processor, a microcontroller, a digital signal processor (DSP), an application specific integrated circuit (ASIC), tensor processing units (TPUs), a graphics processing unit (GPU), a field programmable gate array (FPGA), a programmable logic device (PLD), a radio-frequency integrated circuit (RFIC), a controller, a state machine, gated logic, discrete hardware components, any other processing unit, or any combination or multiplicity thereof. In example embodiments, each processor 3210 can include a reduced instruction set computer (RISC) microprocessor. The processor 3210 may be a single processing unit, multiple processing units, a single processing core, multiple processing cores, special purpose processing cores, co-processors, or any combination thereof. According to certain examples, the processor 3210 along with other components of the computing machine 3200 may be a virtualized computing machine executing within one or more other computing machines. Processors 3210 are coupled to system memory and various other components via a system bus 3234.

The system memory 3230 may include non-volatile memories such as read-only memory (ROM), programmable read-only memory (PROM), erasable programmable read-only memory (EPROM), flash memory, or any other device capable of storing program instructions or data with or without applied power. The system memory 3230 may also include volatile memories such as random-access memory (RAM), static random-access memory (SRAM), dynamic random-access memory (DRAM), and synchronous dynamic random-access memory (SDRAM). Other types of RAM also may be used to implement the system memory 3230. The system memory 3230 may be implemented using a single memory module or multiple memory modules. While the system memory 3230 is depicted as being part of the computing machine 3200, one skilled in the art will recognize that the system memory 3230 may be separate from the computing machine 3200 without departing from the scope of the subject technology. It should also be appreciated that the system memory 3230 is coupled to system bus 3234 and can include a basic input/output system (BIOS), which controls certain basic functions of the processor 3210 and/or operate in conjunction with, a non-volatile storage device such as the storage media 3240.

In example embodiments, the computing device 3200 includes a graphics processing unit (GPU) 3290. Graphics processing unit 3290 is a specialized electronic circuit designed to manipulate and alter memory to accelerate the creation of images in a frame buffer intended for output to a display. In general, a graphics processing unit 3290 is efficient at manipulating computer graphics and image processing and has a highly parallel structure that makes it more effective than general-purpose CPUs for algorithms where processing of large blocks of data is done in parallel.

The storage media 3240 may include a hard disk, a floppy disk, a compact disc read only memory (CD-ROM), a digital versatile disc (DVD), a Blu-ray disc, a magnetic tape, a flash memory, other non-volatile memory device, a solid state drive (SSD), any magnetic storage device, any optical storage device, any electrical storage device, any electromagnetic storage device, any semiconductor storage device, any physical-based storage device, any removable and non-removable media, any other data storage device, or any combination or multiplicity thereof. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any other data storage device, or any combination or multiplicity thereof. The storage media 3240 may store one or more operating systems, application programs and program modules such as module 3250, data, or any other information. The storage media 3240 may be part of, or connected to, the computing machine 3200. The storage media 3240 may also be part of one or more other computing machines that are in communication with the computing machine 3200 such as servers, database servers, cloud storage, network attached storage, and so forth. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The module 3250 may comprise one or more hardware or software elements, as well as an operating system, configured to facilitate the computing machine 3200 with performing the various methods and processing functions presented herein. The module 3250 may include one or more sequences of instructions stored as software or firmware in association with the system memory 3230, the storage media 3240, or both. The storage media 3240 may therefore represent examples of machine or computer readable media on which instructions or code may be stored for execution by the processor 3210. Machine or computer readable media may generally refer to any medium or media used to provide instructions to the processor 3210. Such machine or computer readable media associated with the module 3250 may comprise a computer software product. Each of the operating system, one or more application programs, other program modules, and program data or some combination thereof, may include an implementation of a networking environment. It should be appreciated that a computer software product comprising the module 3250 may also be associated with one or more processes or methods for delivering the module 3250 to the computing machine 3200 via the network 3280, any signal-bearing medium, or any other communication or delivery technology. The module 3250 may also comprise hardware circuits or information for configuring hardware circuits such as microcode or configuration information for an FPGA or other PLD.

The input/output (I/O) interface 3260 may be configured to couple to one or more external devices, to receive data from the one or more external devices, and to send data to the one or more external devices. Such external devices along with the various internal devices may also be known as peripheral devices. The I/O interface 3260 may include both electrical and physical connections for coupling in operation the various peripheral devices to the computing machine 3200 or the processor 3210. The I/O interface 3260 may be configured to communicate data, addresses, and control signals between the peripheral devices, the computing machine 3200, or the processor 3210. The I/O interface 3260 may be configured to implement any standard interface, such as small computer system interface (SCSI), serial-attached SCSI (SAS), fiber channel, peripheral component interconnect (PCI), PCI express (PCIe), serial bus, parallel bus, advanced technology attached (ATA), serial ATA (SATA), universal serial bus (USB), Thunderbolt, FireWire, various video buses, and the like. The I/O interface 3260 may be configured to implement only one interface or bus technology. Alternatively, the I/O interface 3260 may be configured to implement multiple interfaces or bus technologies. The I/O interface 3260 may be configured as part of, all of, or to operate in conjunction with, the system bus 3234. The I/O interface 3260 may include one or more buffers for buffering transmissions between one or more external devices, internal devices, the computing machine 3200, or the processor 3210.

The I/O interface 3260 may couple the computing machine 3200 to various input devices including cursor control devices, touchscreens, scanners, electronic digitizers, sensors, receivers, touchpads, trackballs, cameras, microphones, alphanumeric input devices, any other pointing devices, or any combinations thereof. The I/O interface 3260 may couple the computing machine 3200 to various output devices including video displays (The computing device 3200 may further include a graphics display, for example, a plasma display panel (PDP), a light emitting diode (LED) display, a liquid crystal display (LCD), a projector, a cathode ray tube (CRT), or any other display capable of displaying graphics or video), audio generation device, printers, projectors, tactile feedback devices, automation control, robotic components, actuators, motors, fans, solenoids, valves, pumps, transmitters, signal emitters, lights, and so forth. The I/O interface 3260 may couple the computing device 3200 to various devices capable of input and out, such as a storage unit. The devices can be interconnected to the system bus 3220 via a user interface adapter, which can include, for example, a Super I/O chip integrating multiple device adapters into a single integrated circuit.

The computing machine 3200 may operate in a networked environment using logical connections through the network interface 3270 to one or more other systems or computing machines across the network 3280. The network 3280 may include a local area network (LAN), a wide area network (WAN), an intranet, an Internet, a mobile telephone network, storage area network (SAN), personal area network (PAN), a metropolitan area network (MAN), a wireless network (WiFi), wireless access networks, a wireless local area network (WLAN), a virtual private network (VPN), a cellular or other mobile communication network, Bluetooth, near field communication (NFC), ultra-wideband, wired networks, telephone networks, optical networks, copper transmission cables, or combinations thereof or any other appropriate architecture or system that facilitates the communication of signals and data. The network 3280 may be packet switched, circuit switched, of any topology, and may use any communication protocol. The network 3280 may comprise routers, firewalls, switches, gateway computers and/or edge servers. Communication links within the network 3280 may involve various digital or analog communication media such as fiber optic cables, free-space optics, waveguides, electrical conductors, wireless links, antennas, radio-frequency communications, and so forth.

Information for facilitating reliable communications can be provided, for example, as packet/message sequencing information, encapsulation headers and/or footers, size/time information, and transmission verification information such as cyclic redundancy check (CRC) and/or parity check values. Communications can be made encoded/encrypted, or otherwise made secure, and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure and then decrypt/decode communications.

The processor 3210 may be connected to the other elements of the computing machine 3200 or the various peripherals discussed herein through the system bus 3220. The system bus 3220 represents one or more of any of several types of bus structures, including a memory bus or memory controller, a peripheral bus, an accelerated graphics port, and a processor or local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. It should be appreciated that the system bus 3220 may be within the processor 3210, outside the processor 3210, or both. According to certain examples, any of the processor 3210, the other elements of the computing machine 3200, or the various peripherals discussed herein may be integrated into a single device such as a system on chip (SOC), system on package (SOP), or ASIC device.

Examples may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing examples in computer programming, and the examples should not be construed as limited to any one set of computer program instructions. Further, a skilled programmer would be able to write such a computer program to implement an example of the disclosed examples based on the appended flow charts and associated description in the application text. Therefore, disclosure of a particular set of program code instructions is not considered necessary for an adequate understanding of how to make and use examples. Further, those ordinarily skilled in the art will appreciate that one or more aspects of examples described herein may be performed by hardware, software, or a combination thereof, as may be embodied in one or more computing systems. Moreover, any reference to an act being performed by a computer should not be construed as being performed by a single computer as more than one computer may perform the act.

The examples described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

A “server” may comprise a physical data processing system (for example, the computing device 3200 as shown in FIG. 32) running a server program. A physical server may or may not include a display and keyboard. A physical server may be connected, for example by a network, to other computing devices. Servers connected via a network may operate in the capacity of a server machine or a client machine in a server-client network environment, or as a peer machine in a distributed (e.g., peer-to-peer) network environment. The computing device 3200 can include clients'servers. For example, a client and server can be remote from each other and interact through a network. The relationship of client and server arises by virtue of computer programs in communication with each other, running on the respective computers.

The example systems, methods, and acts described in the examples and described in the figures presented previously are illustrative, not intended to be exhaustive, and not meant to be limiting. In alternative examples, certain acts can be performed in a different order, in parallel with one another, omitted entirely, and/or combined between different examples, and/or certain additional acts can be performed, without departing from the scope and spirit of various examples. Plural instances may implement components, operations, or structures described as a single instance. Structures and functionality that may appear as separate in example embodiments may be implemented as a combined structure or component. Similarly, structures and functionality that may appear as a single component may be implemented as separate components. Accordingly, such alternative examples are included in the scope of the following claims, which are to be accorded the broadest interpretation to encompass such alternate examples. The terminology used herein was chosen to best explain the principles of the embodiments, the practical application or technical improvement over technologies found in the marketplace, or to enable others of ordinary skill in the art to understand the embodiments disclosed herein.

1. An AI-assisted mobile tennis training apparatus comprising:
a motorized chassis supporting a ball hopper;
a programmable ball delivery mechanism including a dual wheel throwing assembly with independently controllable wheel speeds;
a ball dispensing subsystem including a motor-driven feeder coupled to a mechanical switch for detecting ball presence;
a navigation subsystem including omnidirectional wheels and a localization processor configured to determine a position of the apparatus on a tennis court based on visual detection of court line intersections;
a camera subsystem including a plurality of cameras mounted to capture images of at least a player and one or more tennis balls; and
a computing module configured to process image data from the camera subsystem to control the ball delivery mechanism based on at least one of a player position, shot type, or performance metric.

2. The apparatus of claim 1, wherein the omnidirectional wheels comprise Mecanum wheels each driven by an integrated hub motor with closed-loop speed control.

3. The apparatus of claim 1, wherein the computing module comprises an AI model trained to predict a ball flight distance based on wheel speed, spin, and launch elevation parameters, and wherein the apparatus adjusts at least one parameter to achieve a target landing location.

4. The apparatus of claim 1, wherein the camera subsystem comprises three wide-field-of-view cameras mounted with a downward tilt of about 20 degrees and a forward-facing zoom camera mounted with a downward tilt of about 7 degrees.

5. The apparatus of claim 1, wherein the computing module is configured to inhibit navigation movement when a person is detected within a defined safety zone.

6. The apparatus of claim 1, wherein the computing module further comprises a shot analysis engine configured to generate a text-based description of a player's swing mechanics from video input.

7. The apparatus of claim 1, further comprising a mobile application in wireless communication with the computing module, the mobile application configured to control the navigation subsystem, select ball delivery parameters, and display performance metrics.

8. The apparatus of claim 1, wherein the navigation subsystem is further configured to autonomously reposition the apparatus between multiple ball delivery locations on the court during a training session.

9. A method of AI-assisted tennis training, comprising:
positioning a mobile ball feeder on a tennis court;
capturing image data of a player and one or more tennis balls using a plurality of cameras mounted to the mobile ball feeder;
processing the image data with a computing module to determine at least one of player position, player shot characteristics, or ball trajectory;
predicting a landing location for a subsequent ball delivery using an AI model based on ball speed, spin, and launch elevation parameters; and
controlling a ball delivery mechanism of the mobile ball feeder to launch a ball toward a target location determined from the prediction.

10. The method of claim 9, further comprising adjusting the target location in real time based on a measured performance metric from a prior ball delivery.

11. The method of claim 9, further comprising autonomously moving the mobile ball feeder to a second delivery location on the court using an omnidirectional drive system.

12. The method of claim 9, wherein processing the image data further comprises determining a shot type and generating a descriptive text output of the shot using a video-to-language neural network.

13. The method of claim 9, further comprising displaying a graphical interface on a user device showing a court map, apparatus position, and programmed ball delivery targets.

14. The method of claim 9, wherein predicting the landing location comprises constraining ball speed, spin, and launch elevation within predetermined ranges using numerical optimization.

15. The method of claim 9, further comprising inhibiting movement of the mobile ball feeder when a person is detected within a safety zone.

16. A tennis training system comprising:
a mobile ball delivery device including a motorized chassis, a ball hopper, a ball dispensing subsystem, a ball delivery mechanism, a navigation subsystem, a camera subsystem, and a computing module configured to process image data from the camera subsystem to control the ball delivery mechanism;
a remote computing server in communication with the mobile ball delivery device over a network; and
a mobile application executing on a user device, the mobile application configured to:
receive training data from the mobile ball delivery device; display performance analytics generated by an artificial intelligence engine; and transmit control commands to the mobile ball delivery device for navigation and ball delivery.

17. The system of claim 16, wherein the remote computing server stores historical performance data for a plurality of users and generates individualized training plans.

18. The system of claim 16, wherein the artificial intelligence engine is distributed between the mobile ball delivery device and the remote computing server, and the mobile ball delivery device executes real-time ball tracking while the server executes long-term performance trend analysis.

19. The system of claim 16, wherein the mobile application includes a drill builder interface enabling user definition of target locations, spin, speed, and repetition count.

20. The system of claim 16, wherein the mobile application further comprises a skill progression module configured to increase drill difficulty based on detected player improvement.

21. A tennis training system comprising:
a mobile ball delivery device configured to move on a tennis court and deliver tennis balls toward one or more target locations;
a vision system associated with the mobile ball delivery device and configured to capture image data of at least a player and one or more tennis balls;
a control system in communication with the vision system and configured to:
process the image data to determine at least one of player position, ball position, or player performance data; and
adjust operation of the mobile ball delivery device based on the determined data; and
a user interface configured to present performance information and receive user input for controlling the mobile ball delivery device.
